(19) United States
(12) Patent Application Publication
(10) Pub. No.: US 2026/0291883 A1
(43) Pub. Date: Sep. 24, 2026

(54) SYSTEM

(71) Applicant: SoftBank Group Corp., Tokyo (JP)

(72) Inventor: Kosuke SASAKI, Tokyo (JP)

(73) Assignee: SoftBank Group Corp., Tokyo (JP)

(21) Appl. No.: 19/565,655

(22) Filed: Mar. 13, 2026

(30) Foreign Application Priority Data
Mar. 19, 2025 (JP) 2025-045056

(51) Int. Cl. H04L 51/02; G06N 3/045; G06V 10/22

(52) U.S. Cl. CPC H04L 51/02; G06N 3/045; G06V 10/22

(57) ABSTRACT

A system includes a processor that is configured to cause a user interface to receive a selection of a region of interest from among information content viewed by a user or images captured by the user, input a prompt to a generative artificial intelligence model to instruct the generative artificial intelligence model to analyze content of the selected region using natural language processing, and obtain an analysis result from the generative artificial intelligence model, generate one or more search terms based on the obtained analysis result and present the one or more search terms through the user interface, and recognize an emotion of the user and adjust the generated one or more search terms based on the recognized emotion.

### CROSS-REFERENCE TO RELATED APPLICATION

This application is based on and claims priority under 35 USC 119 from Japanese Patent Application No. 2025-045056 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information retrieval systems require the user to manually formulate search queries based on text or images the user is viewing. When the user is browsing information content such as web pages, documents, or captured images, the user must identify relevant terms, convert those terms into appropriate search words, and repeatedly refine the queries. This imposes a cognitive burden on the user and often leads to inefficient search operations, particularly when the user's intent is complex or implicit. Furthermore, existing systems typically do not sufficiently utilize advanced natural language processing by generative artificial intelligence models to deeply analyze the semantic content of user-selected regions. As a result, many systems produce search suggestions that are too generic or only superficially related to the selected content, thereby failing to guide the user to more precise and contextually appropriate information. In addition, conventional systems generally ignore the emotional state of the user during interaction. When the user is frustrated, curious, anxious, or highly engaged, the information needs and the preferred style of search suggestions may differ significantly. However, most systems do not recognize the user's emotion and do not adapt the generated search words based on such emotion, leading to a mismatch between the user's psychological state and the provided search guidance.

Moreover, conventional systems inadequately customize search word generation based on long-term user interests and preferences. Although some systems may record limited history, they often do not leverage generative artificial intelligence models trained on past user behavior data to produce highly personalized search word suggestions. Consequently, users receive uniform suggestions that do not exploit prior interaction patterns and do not effectively reflect individual preferences.

Therefore, there is a need for a system that can: (i) allow the user to select a region of interest in viewed information content or captured images through a user interface; (ii) use a generative artificial intelligence model to perform natural language processing on the selected region and generate search terms based on a detailed analysis result; (iii) recognize the user's emotion and adjust the generated search terms according to the recognized emotion; and (iv) further personalize the search terms using a generative artificial intelligence model trained on past user behavior data representing the user's interests and preferences.

### SUMMARY

In order to solve the above-described problems, according to one aspect of the present invention, there is provided a system comprising a processor, wherein the processor is configured to cause a user interface to receive a selection of a region of interest from among information content viewed by a user or images captured by the user. By enabling direct selection of a region of interest, the system removes the need for the user to manually extract and input text or descriptive terms, and thereby simplifies the initiation of a search process.

The processor is further configured to input a prompt to a generative artificial intelligence model to instruct the generative artificial intelligence model to analyze content of the selected region using natural language processing, and to obtain an analysis result from the generative artificial intelligence model. In this manner, the system utilizes advanced natural language processing capabilities of the generative artificial intelligence model to perform semantic analysis of the selected region, including, for example, entity extraction, intent understanding, and contextual interpretation, thereby yielding a rich analysis result that accurately reflects the meaning of the selected content.

Based on the obtained analysis result, the processor is configured to generate one or more search terms and present the one or more search terms through the user interface. The generation of search terms from the analysis result allows the system to create search queries that are directly aligned with the content semantics, improving the relevance and specificity of the suggestions provided to the user. By presenting the search terms via the user interface, the system allows the user to easily select a desired search term without manually composing a query.

Further, the processor is configured to recognize an emotion of the user and to adjust the generated one or more search terms based on the recognized emotion. For example, when the user is recognized as frustrated or confused, the processor may adjust the search terms toward more explanatory or introductory expressions, whereas when the user is recognized as highly engaged or expert, the processor may adjust the search terms toward more detailed or technical expressions. By reflecting the user's emotional state, the system provides search suggestions that better match the user's immediate needs and psychological condition.

In one embodiment, the processor is configured to use an emotion engine to recognize the emotion of the user. The emotion engine may analyze signals such as facial expressions, voice tone, interaction patterns, or physiological indicators, and may output an emotion label or emotional intensity value. By incorporating a dedicated emotion engine, the system can reliably infer the user's emotional state and provide more appropriate adjustments to the generated search terms.

In another embodiment, the processor is configured to use a generative artificial intelligence model that has been trained on past user behavior data representing interests and preferences of the user to present the one or more search terms. The generative artificial intelligence model may learn patterns from historical browsing, selection behavior, and search activities, and may bias or refine the search term generation to emphasize topics, entities, and query forms that are more likely to be useful to the particular user. By combining the content analysis of the selected region, the recognized emotion of the user, and a personalized generative artificial intelligence model trained on past user behavior data, the system can provide highly tailored, context-aware search word suggestions that significantly reduce the user's cognitive burden and improve search efficiency.

The term “system” refers to an arrangement of one or more hardware and software components that cooperate to perform the functions described in the present specification and claims, and that includes at least one processor and a user interface. The term “processor” refers to any hardware device or combination of devices capable of executing instructions, including but not limited to a central processing unit (CPU), graphics processing unit (GPU), microcontroller, application-specific integrated circuit (ASIC), or programmable logic device, as well as a collection of such elements operating together.

The term “user interface” refers to any hardware and software combination that enables a user to provide input to the system and to receive output from the system, including but not limited to graphical user interfaces, touch screens, keyboards, pointing devices, microphones, speakers, and display devices.

The term “information content” refers to any data or media that can be presented to a user, including but not limited to web pages, electronic documents, text, images, videos, and application screens.

The term “images captured by the user” refers to still or moving image data obtained by an image capture device operated by the user, such as a digital camera, smartphone camera, webcam, or similar recording apparatus.

The term “region of interest” refers to a portion of information content or of an image that is designated by the user via the user interface as being of particular relevance or interest for further analysis or retrieval.

The term “prompt” refers to data, including text, parameters, instructions, or context information, that is provided as input to a generative artificial intelligence model in order to cause the model to perform a specified analysis or generation process.

The term “generative artificial intelligence model” refers to a machine learning model that is configured to generate outputs, such as text, features, analysis results, or other data, based on input prompts, and includes, for example, large language models, generative transformer models, and other neural network-based generative models.

The term “natural language processing” refers to computational techniques and models for analyzing and understanding human language, including but not limited to tokenization, part-of-speech tagging, syntactic parsing, semantic analysis, entity recognition, topic detection, and intent understanding.

The term “analysis result” refers to data generated by the generative artificial intelligence model in response to a prompt, representing an interpretation, extraction, or transformation of the content of the selected region, and may include recognized entities, topics, keywords, summaries, or other semantic information.

The term “search terms” refers to one or more words, phrases, or expressions generated by the system and suitable for use as queries to an information retrieval system, such as a web search engine or database search engine.

The term “present” refers to causing information, including search terms or other outputs, to be visually, audibly, or otherwise perceptibly displayed or provided to the user via the user interface.

The term “emotion of the user” refers to an affective or psychological state of the user, such as frustration, curiosity, interest, confusion, satisfaction, or similar emotional conditions, as determined or inferred by the system.

The term “recognize an emotion” refers to detecting, estimating, or classifying the emotion of the user based on one or more input signals or behavioral indicators, and outputting a representation of the user's emotional state.

The term “adjust the generated search terms” refers to modifying, re-ranking, filtering, supplementing, or otherwise altering one or more generated search terms based on specified criteria, including the recognized emotion of the user.

The term “emotion engine” refers to a hardware and/or software component configured to process one or more inputs, such as facial images, voice signals, interaction logs, or physiological signals, in order to infer and output the emotion of the user.

The term “past user behavior data” refers to recorded information relating to interactions of the user with systems or content over time, including but not limited to browsing history, selection history, search history, click behavior, and response patterns.

The term “interests and preferences of the user” refers to topics, entities, content types, or interaction styles that are inferred or determined to be favored or frequently sought by the user, based on past user behavior data or explicit user settings.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

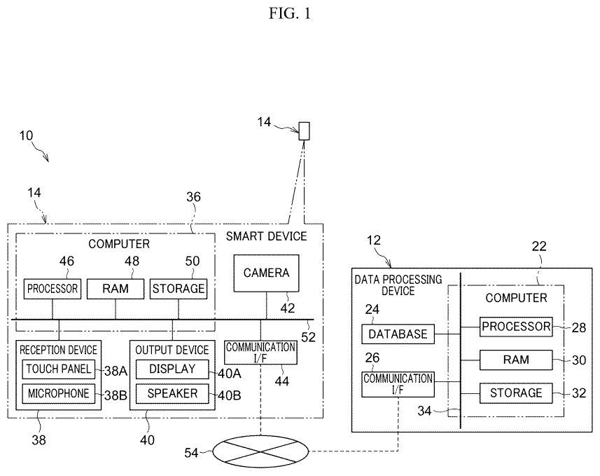

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

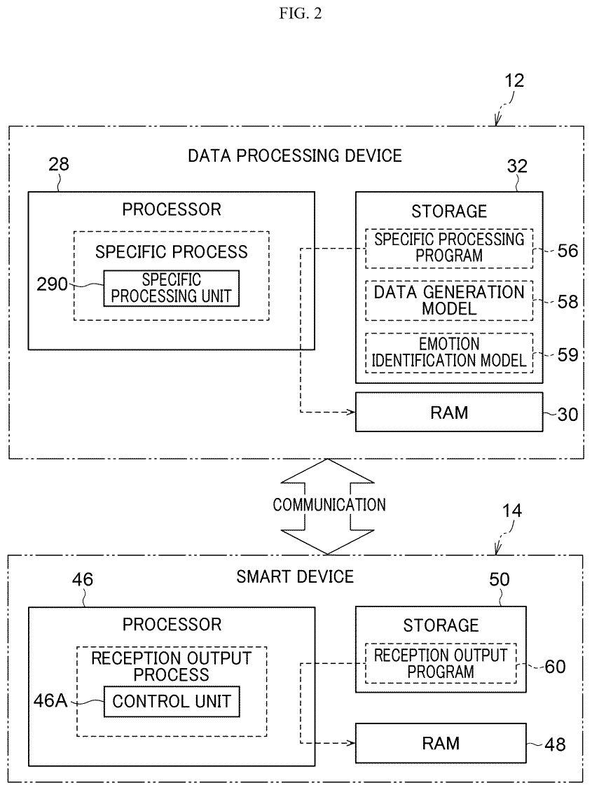

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In modern information environments, users access vast quantities of digital resources, including network-delivered documents, multimedia content, and captured images. Conventional information retrieval techniques generally require the user to manually formulate search queries using a text input interface. However, non-expert users often lack the technical knowledge, domain vocabulary, or linguistic skills needed to translate a vague or visually driven interest into effective search terms. As a result, conventional systems frequently produce suboptimal queries, leading to inefficient retrieval, increased latency in obtaining relevant results, and excessive trial-and-error query reformulation.

Existing systems that suggest queries based on static keyword extraction or simple rule-based heuristics are limited in their ability to capture the semantic context of a specific portion of a displayed resource. These systems typically do not integrate heterogeneous analysis of both textual and visual content selected by the user, and thus fail to fully utilize the rich information present in the selected region. Furthermore, such systems generally do not adapt the generated search terms to the user's emotional state, preferences, or interaction history, resulting in suggestions that may be technically relevant but contextually inappropriate, cognitively overwhelming, or misaligned with the user's current intent.

From the perspective of computer technology, there is a need to improve how computing systems process user-selected regions of content, synthesize analysis results from text and images, and automatically generate high-quality search terms. In particular, there is a need for an improved processing pipeline that transforms raw coordinate selections into structured semantic data, constructs prompt sentences for a generative artificial intelligence model in a systematic manner, invokes that model to generate retrieval terms, and post-processes the generated terms in light of user attributes and emotional state. Without such improvements, computing systems consume unnecessary computational and network resources due to redundant or low-quality queries, fail to provide an efficient human-computer interaction loop, and cannot effectively leverage advanced generative models in a controllable and safe way within the information retrieval workflow.

Accordingly, an object of the present invention is to provide a computer-implemented system that improves the technical functioning of information retrieval by: (i) enabling coordinate-based selection and precise extraction of underlying textual and visual data; (ii) performing integrated analysis using natural language processing and image recognition resources; (iii) constructing structured prompt sentences that instruct a generative artificial intelligence model to produce context-aware information retrieval terms; (iv) executing post-processing operations including deduplication, safety filtering, and relevance ranking; and (v) dynamically adjusting the generated terms based on an estimated emotional state and learned preferences of the user. By implementing these operations in a coordinated manner at the processor level, the system improves the quality and efficiency of query generation, reduces unnecessary computational overhead associated with ineffective searches, and enhances the overall performance and usability of computer-based information retrieval.

The specific processing by the specific processing unit 290 of the data processing device 12 in Example 1 is realized by the following means.

The present invention provides a server comprising a processor configured to receive, via a user interface, a designation of a region of interest within at least a portion of a display area of information content or an image acquired by an image acquisition device, to map coordinate information of the designated region to underlying character information or image information in an information resource, to obtain the character information and the image information corresponding to the coordinate information, to analyze the obtained character information by using a natural language processing resource to extract semantic information and concept information, to analyze the obtained image information by using an image recognition resource to extract object information and attribute information, to generate integrated analysis result data by combining extraction results from the character information and the image information, to construct a prompt sentence including at least a summary of the analysis result data, extracted concept information, and generation conditions based on the analysis result data and attribute information or behavior history information of a user, to transmit the prompt sentence together with instruction information requesting an inference process to a generative artificial intelligence model so that response information including a plurality of information retrieval terms related to the analysis result data is generated by the generative artificial intelligence model, to acquire the response information from the generative artificial intelligence model, to extract the information retrieval terms from the response information, to perform duplicate elimination processing, safety determination processing, and relevance calculation processing on the information retrieval terms, to determine a plurality of ranked candidate retrieval terms and present the candidate retrieval terms together with classification information and relevance information via the user interface, to acquire expression information, voice information, or operation information of the user, to estimate an emotional state of the user by using an emotion recognition resource based on the acquired information, to adjust content or presentation order of the candidate retrieval terms in accordance with the emotional state, and to generate and transmit request information using a candidate retrieval term selected by the user as a retrieval request to an information retrieval resource and present a retrieval result to the user. This enables the computing system to technically improve information retrieval processing by transforming region-based user interactions into semantically rich prompt sentences for a generative artificial intelligence model, generating and refining high-quality search terms in a structured and adaptive manner, reducing redundant and low-value query traffic, and providing search suggestions that are both context-aware and dynamically tailored to the user's state and preferences, thereby enhancing computational efficiency and effectiveness of the overall retrieval pipeline.

The term “user interface” refers to a hardware and/or software interface through which a user provides input to, and receives output from, the system, including graphical display elements, input fields, buttons, and other interactive components presented on a display device.

The term “information content” refers to digital data representing at least one of text, graphics, images, audio, video, or structured documents that are rendered or otherwise made accessible to a user by a computing device.

The term “image acquisition device” refers to a hardware component or system configured to capture visual information, including, for example, a camera, scanner, or sensor-equipped imaging module that produces digital image data.

The term “display area” refers to a region of a display device in which information content or images are rendered for presentation to a user by a computing device.

The term “region of interest” refers to a portion of the display area specified by the user as being relevant or noteworthy, and which is associated with underlying character information and/or image information in an information resource.

The term “input/output device” refers to one or more hardware components, such as a pointing device, touch detection device, keyboard, or microphone, used to receive input from a user and/or provide output to a user.

The term “pointing device” refers to an input device, such as a mouse, trackpad, stylus, or similar device, that enables a user to move a pointer and designate positions or regions on a display area.

The term “touch detection device” refers to an input device or sensor, such as a touch screen or touch panel, that detects physical contact or proximity of a user's finger or stylus and generates corresponding input signals.

The term “coordinate information” refers to data indicating positional values, such as x-y coordinates or equivalent spatial descriptors, specifying one or more locations or regions within a display area.

The term “information resource” refers to a digital data source, such as a web document, electronic document, database record, or multimedia file, from which character information or image information is derived and rendered to the user.

The term “character information” refers to textual data, including sequences of characters, words, and symbols, that can be processed as a string or structured text segment by a computing system.

The term “image information” refers to digital data representing visual content, such as pixel values, color channels, or encoded bitstreams of images or portions of images.

The term “processor” refers to a hardware-implemented computation unit, such as a central processing unit, graphics processing unit, or specialized processing circuit, configured to execute instructions and perform the operations described herein.

The term “information processing resource” refers to a computing module, service, or subsystem, implemented locally or remotely, that performs computational operations such as natural language processing, image recognition, or data analysis.

The term “natural language processing resource” refers to hardware, software, or a service configured to perform analysis of human language text, including operations such as tokenization, entity extraction, semantic analysis, and concept identification.

The term “image recognition resource” refers to hardware, software, or a service configured to analyze image information to detect, classify, or recognize objects, scenes, text, or other visual features.

The term “semantic information” refers to data representing meanings, roles, or relationships inferred from character information, such as identified entities, topics, or contextual interpretations.

The term “concept information” refers to data representing abstracted notions, categories, or themes derived from one or more segments of character information or image information.

The term “object information” refers to data describing physical or logical entities detected within image information, including identifiers, types, or labels of detected targets.

The term “attribute information” refers to data describing properties or characteristics associated with objects or concepts, such as location, category, type, time, or other qualifying features.

The term “analysis result data” refers to structured data generated by combining outputs from natural language processing resources and image recognition resources, representing a unified semantic interpretation of selected character and image information.

The term “attribute information of a user” refers to user-related profile data, such as demographic information, language preferences, expertise level, or other static or semi-static characteristics.

The term “behavior history information” refers to data representing past interactions of a user with computing systems, including prior searches, selections, navigation patterns, or usage logs.

The term “prompt sentence” refers to a text string or structured textual instruction that encodes analysis result data, concept information, and generation conditions, and is provided as input to a generative artificial intelligence model to direct its inference processing.

The term “generation conditions” refers to parameters or constraints included in the prompt sentence that influence the behavior of a generative artificial intelligence model, such as target language, number of outputs, tone, length, or domain focus.

The term “generative artificial intelligence model” refers to a machine-learned model configured to generate text or other content in response to input instructions, including, for example, a large-scale neural network trained on data to perform inference based on prompt inputs.

The term “instruction information requesting an inference process” refers to data specifying that the generative artificial intelligence model should perform a generation or prediction operation using a given prompt sentence, optionally including model selection or configuration parameters.

The term “response information” refers to data returned by the generative artificial intelligence model in response to the prompt sentence and instruction information, including generated text, intermediate structures, or metadata.

The term “information retrieval term” refers to a word, phrase, or expression that can be used as a query or part of a query to an information retrieval resource in order to obtain related search results.

The term “duplicate elimination processing” refers to a computational procedure that detects and removes identical or substantially similar information retrieval terms from a set of candidate terms.

The term “safety determination processing” refers to a computational procedure that evaluates information retrieval terms for compliance with predetermined safety or content policies and filters or modifies terms that violate such policies.

The term “relevance calculation processing” refers to a computational procedure that assigns one or more scores or measures indicating how strongly an information retrieval term relates to analysis result data, user attributes, or context.

The term “candidate retrieval term” refers to an information retrieval term that has been selected as a potential search query after processing steps including extraction, filtering, and ranking.

The term “classification information” refers to data indicating one or more categories, types, or groupings assigned to a candidate retrieval term, such as topical, functional, or user-intent-based classifications.

The term “relevance information” refers to data representing the degree or ranking of relevance associated with a candidate retrieval term with respect to the underlying selected content or user context.

The term “expression information” refers to data representing observable facial or bodily expressions of a user, acquired by a sensor, camera, or other input device and used for emotional state estimation.

The term “voice information” refers to audio data representing spoken sounds or speech of a user, acquired by a microphone or equivalent input apparatus and used for emotional or intent analysis.

The term “operation information” refers to data representing user interactions with an interface, such as click patterns, gesture patterns, typing speed, or input timing, which may be analyzed to infer user state.

The term “emotion recognition resource” refers to hardware, software, or a service configured to estimate or classify a user's emotional state based on one or more of expression information, voice information, and operation information.

The term “emotional state” refers to an inferred or estimated psychological condition of a user, such as calmness, frustration, curiosity, or excitement, represented in a form usable for computational adaptation of system behavior.

The term “request information” refers to data forming a retrieval request, including at least an information retrieval term and optionally additional parameters, that is transmitted to an information retrieval resource.

The term “information retrieval resource” refers to a hardware and/or software system, such as a search server or retrieval service, that receives request information and returns search results or related information.

The term “retrieval result” refers to data returned by an information retrieval resource in response to request information, including lists of items, documents, links, or summaries relevant to an information retrieval term.

The term “emotion estimation engine” refers to a specific emotion recognition resource implemented as a software module, hardware module, or combination thereof, that processes signals from input devices to estimate an emotional state of a user.

The term “storage device” refers to a persistent or semi-persistent memory component, such as a magnetic storage, solid-state storage, or non-volatile memory, used to store attribute information, behavior history information, and model-related data.

The term “trained generative artificial intelligence model” refers to a generative artificial intelligence model that has undergone a learning process using training data, including behavior history information of users, to internalize patterns of user interest or preference.

The term “interest or preference of the user” refers to one or more inferred tendencies, favored topics, or habitual choices of a user, derived from analysis of the user's past behavior history information.

The term “construction of the prompt sentence” refers to the process of assembling and formatting components such as analysis result data, concept information, generation conditions, and user-related information into a textual form suitable for input to a generative artificial intelligence model.

In one embodiment, a server, a terminal, and a network-connected generative AI model cooperate to implement the claimed system. The server includes at least one processor, a main memory, a non-volatile storage device, a network interface, and a display interface. The terminal includes at least one processor, a memory, a touch-sensitive display or pointing-device-driven display, and one or more input/output devices such as a mouse, a keyboard, a microphone, or a camera. The server and the terminal communicate over a communication network using a protocol such as HTTPS over TCP/IP.

The server executes server-side programs implemented, for example, using a server framework such as a general-purpose scripting environment or web application framework. The terminal executes client-side programs implemented, for example, as a web application using a browser rendering engine, or as a native application using an operating system SDK. The browser rendering engine may be of a type that parses markup and style documents and renders a document object model (DOM) tree to a screen, and exposes APIs for coordinate-to-content mapping.

The terminal displays information content or images in a display area by using a rendering engine and a graphics subsystem. The terminal stores the rendered content in one or more data structures such as a DOM tree for text content and frame buffers or image objects for images. The user views the display area and uses a pointing device or a touch detection device to designate a region of interest. The terminal maintains a selection structure in memory, for example, an object containing coordinate pairs, a bounding rectangle, and references to underlying content nodes. The terminal associates the coordinate information with the DOM nodes and image data by calling APIs such as hit-testing or layout queries provided by the rendering engine. This mapping from visual coordinates to underlying structured content is a technical operation that cannot be performed reliably by manual human inspection alone at the speed and precision required for real-time interaction. The terminal sends, via the network interface, the coordinate information and the underlying character information and/or image information to the server in a structured message. The structured message may include fields such as selectionType, coordinates, textSegment, imageCrop, userLanguage, and contextIdentifier. The server receives this structured message and stores it in volatile memory for further processing. In some embodiments, the server also stores anonymized metadata in a persistent storage device for later learning and optimization.

The server uses information processing resources to analyze the character information and the image information. For text analysis, the server calls a natural language processing resource, such as a text analysis microservice or an external natural language processing API. The server passes the character information as an input string and may specify language, domain, and requested operations. The natural language processing resource performs operations such as tokenization, sentence segmentation, part-of-speech tagging, named entity recognition, and dependency parsing, using a trained statistical or neural model. Internally, the natural language processing resource may use, for example, a transformer-based encoder that converts token sequences into contextual embeddings, and then applies classification layers to identify entities and key phrases. The server receives, as structured output, a list of entities, concepts, and confidence scores, and stores them in an analysis result object.

For image analysis, the server calls an image recognition resource, such as an object detection or image classification microservice or an external image recognition API. The server passes the image information, for example, as a cropped image region encoded in a compressed format and optionally resized. The image recognition resource applies a convolutional or transformer-based neural network to the image data to detect objects, landmarks, scenes, and text. For example, the resource may use a feature extraction backbone to generate feature maps and then apply one or more detection heads to output bounding boxes and labels, with associated probability scores. The server receives structured output including detected object labels, associated scores, and optionally detected text via optical character recognition. The server merges these results with the results from the text analysis.

The server combines outputs from the natural language processing resource and the image recognition resource into unified analysis result data. The server implements this merge by constructing a semantic graph or a key-value structure in which identified entities, concepts, locations, and object labels are normalized and de-duplicated. For example, the server may apply a canonicalization process where different variations of a name or concept are mapped to a common identifier. The server also associates each item in the analysis result data with metadata such as source type (text or image), confidence score, and relevance score to the user's selected region. This structured analysis result data reduces redundancy and captures multi-modal context, which directly improves the subsequent generative process by providing clearer and more compact input to the generative AI model.

The server then constructs a prompt sentence for a generative AI model. The server retrieves user attribute information and behavior history information from a storage device, such as a database storing user preferences, prior selections, and past search interactions. The server applies a rule-based template or a template augmented by a learned component to embed the analysis result data and user information into a natural-language instruction. For example, the server may produce a prompt sentence of the form: “The user has selected an image region recognized as ‘Gothic cathedral, Cologne Cathedral, Germany’. Based on this description, generate 8 short and user-friendly search queries that cover history, architectural features, visiting tips, and nearby attractions. Output the queries as a plain list, one per line.”

In another example, the server may produce a prompt sentence for text-based selection: “The user has selected the following text: ‘Floating offshore wind farms enable power generation in deepwater locations using advanced mooring systems and dynamic cables.’ Extract the main concepts and generate 7 concise web search queries that a general user might type into a search engine to learn more about this topic. Focus on basics, advantages, engineering challenges, and current real-world projects.”

The server explicitly includes generation conditions such as output language, number of queries, length constraints, and prohibited content types in the prompt sentence. This explicit encoding of conditions controls the behavior of the generative AI model and ensures that the generated outputs follow system-specific constraints rather than generic text generation.

The server supplies the constructed prompt sentence and model configuration parameters to a generative AI model hosted on a model-serving platform. The generative AI model may be implemented as a large-scale neural network with a transformer architecture, including multiple layers of self-attention, feed-forward sublayers, layer normalization, and learned token embeddings. The model receives the prompt sentence tokenized into subword units, and performs inference by sequentially predicting output tokens conditioned on the prompt. The server configures inference parameters such as temperature, top-k or top-p sampling thresholds, maximum output length, and stop sequences to balance diversity and determinism.

The server does not treat the generative AI model as a black box. Instead, the server shapes the input and the decoding process based on technical criteria to improve computational efficiency and output quality. For example, the server may introduce domain-specific control tokens or prefixes in the prompt to bias the model toward generating query-like phrases rather than long descriptive paragraphs. The server may also restrict decoding to shorter sequences, thereby reducing computation time and network traffic.

The generative AI model produces output text that includes multiple candidate information retrieval terms. The server parses the output according to the expected format, for example, by splitting lines or using markers defined in the prompt. The server then applies a series of post-processing algorithms. First, the server executes duplicate elimination processing by computing similarity scores, such as cosine similarity over vector representations of terms, and discarding terms whose similarity exceeds a threshold.

Second, the server performs safety determination processing by applying a content moderation classifier or rule set against a list of disallowed terms and patterns. Third, the server computes relevance scores for each term based on factors such as overlap with key entities in the analysis result data, user-specific topic weights derived from behavior history, and confidence measures from the generative model. The server uses these scores to rank the candidate retrieval terms.

The terminal receives the ranked candidate retrieval terms from the server. The terminal displays the candidate retrieval terms via the user interface as selectable items. The terminal may group them by classification information, such as “history,” “technical details,” or “practical information,” and may display associated relevance scores or visual emphasis based on ranking. This structured presentation reduces cognitive load on the user and allows for faster selection, which is a technical improvement of the user interface layer by minimizing the number of interactions needed to reach a relevant query.

The server additionally uses emotion recognition to adapt the generated retrieval terms. The terminal acquires user expression information via a camera, user voice information via a microphone, and operation information such as rapid repeated clicks or long dwell times via input event logs. The terminal transmits features extracted from these signals, such as facial expression vectors, prosody statistics, and interaction patterns, to the server. An emotion estimation engine implemented on the server receives these features and runs an emotion classification model, which may be a neural network trained on multimodal features with a loss function tailored to emotional labels. The emotion estimation engine outputs an estimated emotional state, for example, calm, frustrated, confused, or highly engaged.

Based on the estimated emotional state, the server adjusts either the content or the presentation order of the candidate retrieval terms. For example, when the user is estimated to be frustrated or confused, the server promotes simpler, more general queries to the top of the list and suppresses highly technical terms. When the user is estimated to be highly engaged, the server emphasizes more detailed or advanced queries. This adaptive behavior is controlled by algorithms that modify ranking weights and selection filters based on emotional state categories. As a result, the system reduces the number of unsuccessful search attempts and re-queries, which in turn lowers network traffic and processing load on the information retrieval resource.

The system improves computer technology beyond mere automation of human query formulation. In particular, the server organizes data in specialized data structures (semantic graphs, analysis result objects, ranked term lists) and applies non-conventional processing flows (multi-modal merging, prompt construction, model-guided generation, and emotion-adaptive ranking) that are specifically designed to interact with large-scale generative models. The integration of coordinate-based selection, multimodal semantic analysis, structured prompt sentence construction, and controlled generative decoding leads to higher precision and lower redundancy in search queries compared to conventional keyword extraction alone. This results in improved throughput in information retrieval servers, reduced number of network calls due to fewer reformulated queries, and reduced computational resource usage per successfully resolved information need.

The generative AI model itself may be trained offline before deployment using a large corpus that includes histories of user selections, associated analysis result data, and successful search queries. During training, the model receives as input a representation of analysis result data and user context, and learns to output query-like text. The training process may use an objective function such as cross-entropy loss between predicted tokens and ground-truth query tokens, and a weight update algorithm such as stochastic gradient descent with adaptive learning rates. The model parameters are updated iteratively until a validation metric, such as perplexity or query success rate proxy, stabilizes. To improve robustness, data augmentation may be used to vary wording and reorder concepts in prompts, which teaches the model to handle a range of input structures. By tailoring the training to the task of query generation from structured analysis data, the system achieves better alignment of generated terms with user needs and content semantics, thereby improving retrieval effectiveness.

In one alternative embodiment, the server executes some or all of the natural language processing and image recognition operations locally, without relying on external APIs. In such a configuration, the server loads pre-trained models into memory and uses optimized libraries for numeric computation, which reduces network latency and dependency on external services. In another alternative embodiment, the terminal performs the coordinate-to-content mapping and text preprocessing locally, and only sends a compact representation of the content to the server, thereby reducing bandwidth consumption. In yet another embodiment, the emotion estimation engine runs partly on the terminal for privacy-sensitive features, and only high-level emotional state labels are sent to the server. In a further embodiment, the server supports multiple generative AI models with different sizes or capabilities and dynamically selects one based on the complexity of the analysis result data or the current system load. For example, the server may use a smaller model for simple selections to reduce computation time, and a larger model for complex or ambiguous selections. This model selection strategy contributes to reduced latency and more efficient use of computational resources.

In all of these embodiments, the server, the terminal, and the generative AI model cooperate through specific data structures and algorithms that are designed to transform raw coordinate-based user input into high-quality, context-sensitive information retrieval terms. The technical design of the analysis pipeline, the prompt sentence construction, the generative decoding control, the post-processing, and the emotion-adaptive ranking produces measurable improvements in precision, latency, and resource consumption in computer-based information retrieval systems, and provides capabilities that cannot be achieved by manual query generation or simple automation thereof.

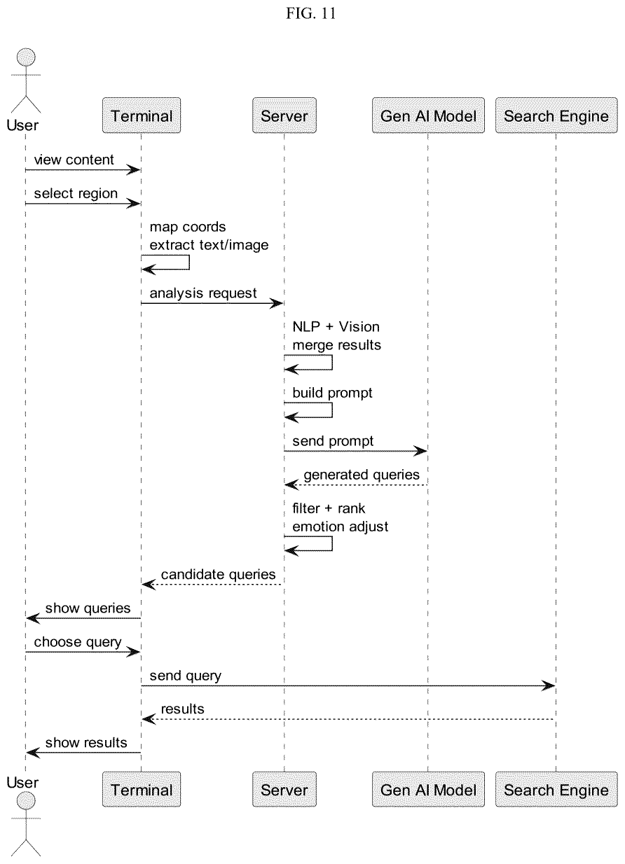

The following describes the processing flow using FIG. 11.

### Step 1:

User views information content or an image and selects a region of interest.

User operates a pointing device or a touch detection device on the terminal to drag or tap on a display area showing information content or an image.

Input: Visually rendered information content or image on the terminal display, and low-level input events (mouse down/move/up, touch start/move/end).

Output: A designated region of interest represented as screen coordinate data (for example, x-y coordinates of a bounding box).

User moves the pointer or finger to enclose the desired region, and the terminal visually highlights the current selection so that the user can confirm the targeted area.

### Step 2:

Terminal maps the selected coordinates to underlying content and extracts raw data.

Terminal receives the coordinate data from Step 1 and uses rendering engine APIs to determine which DOM nodes or which portion of an image buffer intersect with the selected region.

Input: Coordinate data (bounding box or polygon) and internal representations such as a DOM tree for text and image buffers for images.

Output: Character information (text segment) and/or image information (cropped image region) corresponding to the region of interest.

Terminal performs hit-testing and layout calculations, slices text ranges that fall inside the coordinates, and crops the relevant pixels from the original image into a separate image object stored in memory.

### Step 3:

Terminal performs local pre-processing on the extracted character and image information. Terminal normalizes the extracted text by removing markup and excess whitespace, and optionally detects the text language using a lightweight language detection routine.

Terminal resizes and compresses the cropped image region to meet the requirements of downstream analysis services.

Input: Raw character information and cropped image information from Step 2.

Output: Normalized text string with optional language metadata and a resized, encoded image object ready for transmission.

Terminal applies string operations and image resampling algorithms, and then packages the processed data into a structured request payload including selection type, coordinates, and context identifiers.

### Step 4:

Terminal sends a structured analysis request to the server.

Terminal establishes or uses an existing secure network connection to transmit the pre-processed text and image data, together with metadata, to the server.

Input: Structured payload containing normalized character information, processed image information, coordinate data, and user context.

Output: A network message delivered to the server endpoint that initiates server-side analysis.

Terminal serializes the payload into a format such as JSON and invokes an HTTPS POST request to a designated server API.

### Step 5:

Server receives the request and stores the selection context.

Server accepts the incoming network message and parses the structured payload into internal data structures, and optionally logs metadata for later learning.

Input: Structured request message from the terminal containing selectionType, textData, imageData, coordinates, and userContext.

Output: In-memory objects representing the selection, plus optional log entries in persistent storage.

Server validates the payload, checks authentication tokens, and allocates memory records to hold the extracted text, image, and associated metadata.

### Step 6:

Server executes natural language processing on the character information.

Server forwards the character information and relevant parameters to a natural language processing resource and receives structured semantic annotations.

Input: Normalized text string and optional language/context parameters from Step 5.

Output: Semantic information including entities, key phrases, part-of-speech tags, and confidence scores.

Server invokes a text analysis routine or service that tokenizes the text, computes contextual embeddings, performs entity recognition, and returns a list of identified concepts and their scores; the server then stores these results in an analysis result object.

### Step 7:

Server executes image recognition on the image information.

Server submits the cropped image region to an image recognition resource, which detects objects, landmarks, text, and other visual features.

Input: Processed image data and optional image metadata from Step 5.

Output: Object information and attribute information including detected labels, bounding boxes, OCR text, and confidence values.

Server calls an image analysis module that processes the image with a feature extractor and detection heads and then parses the returned JSON or equivalent data into an internal structure linked to the same analysis result object used for text.

### Step 8:

Server merges text and image analysis into integrated analysis result data.

Server combines the semantic information from text analysis and the object and attribute information from image recognition into a unified representation.

Input: Structured text analysis results from Step 6 and structured image analysis results from Step 7.

Output: Integrated analysis result data containing normalized entities, concepts, object labels, attributes, and associated scores.

Server performs normalization (for example, mapping variant names to canonical identifiers), de-duplication, and relevance scoring, and then builds a combined data structure that links each concept or object to its origin (text or image) and its confidence.

### Step 9:

Server retrieves user attribute and behavior history information.

Server accesses a storage device to obtain user profile data and past interaction logs associated with the current user or session.

Input: User identifier or context token from Step 5.

Output: User attribute information (such as language preference and expertise level) and behavior history information (such as prior selections and successful queries).

Server queries a database with the user identifier, loads the retrieved records into memory, and converts them into feature vectors or structured fields that can be consumed in prompt construction and ranking.

### Step 10:

Server constructs a prompt sentence for a generative AI model.

Server embeds the integrated analysis result data and user-related information into a natural-language instruction that defines the generation task and constraints.

Input: Integrated analysis result data from Step 8 and user attribute and behavior history information from Step 9.

Output: A prompt sentence describing the selected content, listing key entities and concepts, and specifying generation conditions such as language, number of queries, and style.

Server applies a template-based or rule-augmented algorithm that formats the analysis results and user data into a coherent instruction, for example:

“The user has selected the following text: ‘Floating offshore wind farms enable power generation in deepwater locations using advanced mooring systems and dynamic cables.’ Extract the main concepts and generate 7 concise web search queries that a general user might type into a search engine to learn more about this topic. Focus on basics, advantages, engineering challenges, and current real-world projects.”

### Step 11:

Server sends the prompt sentence to the generative AI model and configures inference.

Server transmits the constructed prompt sentence and associated parameters to a generative AI model endpoint, specifying the decoding settings.

Input: Prompt sentence from Step 10 and model parameters such as temperature, maximum length, and sampling strategy.

Output: A model inference request that initiates generation of candidate information retrieval terms.

Server tokenizes the prompt, packages it with configuration options, and issues a request to the model-serving API, then waits for the model's response.

### Step 12:

Server receives generated text and extracts candidate information retrieval terms.

Server obtains the generative AI model's response and parses the output text into individual candidate queries.

Input: Generated text sequence returned by the generative AI model from Step 11.

Output: A list of raw candidate information retrieval terms derived from the model output.

Server splits the response using delimiters such as line breaks or list markers as specified in the prompt sentence, trims whitespace, and discards empty or malformed entries.

### Step 13:

Server performs duplicate elimination processing on the candidate terms.

Server analyzes similarity among the raw candidate terms to remove redundant or near-duplicate items.

Input: List of raw candidate information retrieval terms from Step 12.

Output: A reduced list of distinct candidate retrieval terms.

Server converts each term into a normalized form (for example, lowercased text) and may compute vector representations; server then applies a similarity threshold to identify and remove terms that are effectively duplicates.

### Step 14:

Server performs safety determination processing on the candidate terms.

Server evaluates each distinct candidate term against safety policies and content constraints to filter out or modify inappropriate terms.

Input: Reduced list of distinct candidate retrieval terms from Step 13.

Output: A filtered list of candidate retrieval terms compliant with predefined safety and content rules.

Server checks the terms against blocklists, pattern rules, or a moderation classifier and either removes unsafe terms or replaces sensitive fragments, thereby ensuring safe downstream use.

### Step 15:

Server calculates relevance scores and ranks the candidate retrieval terms.

Server computes relevance measures for each remaining candidate term using the integrated analysis result data and user-related information, then orders the terms accordingly.

Input: Filtered candidate retrieval terms from Step 14, integrated analysis result data from Step 8, and user attribute and behavior history information from Step 9.

Output: A ranked list of candidate retrieval terms, each associated with relevance scores and classification labels.

Server compares each term with key entities and concepts, weighs terms according to user interests inferred from history, and generates one or more numerical scores; server sorts the list based on these scores and assigns category tags such as “history” or “practical information.”

### Step 16:

Server estimates the emotional state of the user and adjusts the ranked list.

Server processes multimodal signals related to the user and uses an emotion recognition resource to infer an emotional state, then adapts the candidate term list accordingly.

Input: Expression, voice, or operation features transmitted from the terminal, and the ranked list of candidate retrieval terms from Step 15.

Output: An emotion-adapted ranked list of candidate retrieval terms reflecting the user's current state.

Server runs an emotion estimation model on the received features to classify the user's emotional state and then adjusts ranking weights, prunes overly complex terms when confusion is indicated, or emphasizes advanced terms when engagement is high.

### Step 17:

Server sends the final candidate retrieval terms to the terminal.

Server prepares a response payload containing the emotion-adjusted, ranked candidate terms and associated metadata and transmits it to the terminal.

Input: Emotion-adapted ranked list of candidate retrieval terms from Step 16.

Output: A structured response message containing candidate retrieval terms, categories, and relevance indicators delivered to the terminal.

Server serializes the data into a response object, attaches any necessary identifiers for subsequent selection tracking, and issues an HTTPS response.

### Step 18:

Terminal presents the candidate retrieval terms to the user.

Terminal receives the response, parses the candidate terms and metadata, and renders them within the user interface as selectable items near the selected region.

Input: Structured response message from Step 17.

Output: A visible list or set of interface elements representing the candidate retrieval terms with visual cues indicating relevance and categories.

Terminal updates the display by creating buttons, list entries, or chips, grouping them by classification information and highlighting higher-ranked terms to guide the user.

### Step 19:

User selects one of the presented candidate retrieval terms.

User reviews the displayed candidate terms and interacts with the user interface to choose a term that best matches the desired information need.

Input: Displayed candidate retrieval terms from Step 18 and a user input action such as a tap or click.

Output: A selected retrieval term together with its identifier and context.

User actuates the interface element corresponding to the chosen term, and the terminal records which term was selected and forwards this selection to the next processing step.

### Step 20:

Terminal sends a retrieval request to an information retrieval resource and displays the result.

Terminal constructs a query message using the selected retrieval term and transmits it to an information retrieval resource, then receives and shows the returned results.

Input: Selected retrieval term and associated metadata from Step 19.

Output: Retrieved result data displayed to the user, such as a list of relevant documents, links, or summaries.

Terminal embeds the selected term into a request URL or API payload, performs a network call to a search backend, parses the returned result set, and renders the search results on the display, thereby completing the information retrieval cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information retrieval and recommendation systems typically rely on manually entered keywords, static rule-based pipelines, or simple statistical models that are loosely coupled to the user's actual context. Such systems suffer from several technical problems when deployed on modern computing platforms that deliver large volumes of heterogeneous content (for example, text, images, and video) to user terminals. First, conventional systems are not architected to precisely capture and exploit a fine-grained “region of interest” within displayed content. Even when a user taps or selects a specific portion of a screen, the backend often treats the entire page or whole image as the query context. As a result, the computing system expends processing resources on irrelevant data, produces search terms that poorly reflect the user's actual intention, and increases network traffic by transmitting more data than is necessary.

Second, traditional systems do not integrate multi-modal analysis pipelines in a coordinated, machine-understandable way. Text processing components and image processing components are generally implemented as independent modules that output unstructured or loosely structured results. Because there is no unified structured representation of the user's intention or interest target, downstream ranking and recommendation components cannot systematically exploit the analysis outputs. This leads to inefficient computation, redundant model invocations, and suboptimal use of processor, memory, and accelerator resources.

Third, existing systems typically treat all user interactions as emotionally neutral. Computing operations generating search terms or recommendation lists are not conditioned on recognized emotional states, even though user emotion strongly influences which system outputs are perceived as relevant, acceptable, or non-intrusive. Without emotion-aware control, the system continues to generate and present results in the same manner regardless of user frustration, boredom, or satisfaction, which in turn causes wasted computing cycles, unnecessary server-client round trips, and lower overall effectiveness of the interaction.

Fourth, user preference learning is often handled by generic recommendation models that are decoupled from generative models used to create explanations or prompts. This disjoint architecture limits the ability of the computing system to adapt prompt sentences and generative outputs based on accumulated user behavior. The result is that generative processing remains largely static and does not evolve with the user's long-term interests, leading to inefficient use of powerful generative models and failure to converge toward individually optimized information delivery.

Accordingly, there is a need for a computer-implemented technique that (i) captures fine-grained regions of interest on a terminal, (ii) performs coordinated multi-modal analysis to generate a unified structured representation of user intent, (iii) uses such structured data to drive the construction of prompt sentences for a generative AI model, (iv) dynamically adjusts search term sequences and recommendation lists based on recognized user emotion, and (v) continuously updates the generative AI model or recommendation algorithms using user behavior history. By solving these issues at the system and processor-configuration level, the invention improves the functioning of the computer itself in terms of resource utilization, responsiveness, and accuracy of context-sensitive information delivery.

The specific processing by the specific processing unit 290 of the data processing device 12 in Application Example 1 is realized by the following means.

The present invention provides a server comprising a processor configured to control a user interface including an input device or a gaze detection device and a display device so as to identify a region of interest within information data displayed on the display device or image data acquired by an imaging device, and to acquire position information and content data corresponding to the region of interest; to classify the acquired content data into text data and image data; to execute, for the text data, a natural language processing program including at least tokenization, part-of-speech tagging, named entity extraction, and topic extraction, and to execute, for the image data, an image processing program or a machine learning model including at least object detection, face detection, region extraction, and feature calculation; to integrate analysis results of the text data and the image data to generate structured data representing a user intention or a user interest target; to obtain related information candidates from a related information candidate database or a search index on the basis of the structured data; to generate a prompt sentence for a generative AI model by using the related information candidates and the structured data, to input the prompt sentence into the generative AI model, and to receive generated result data including at least explanatory text or recommendation information; to generate, on the basis of the generated result data, at least one of a search term sequence or a recommendation information list, to present the search term sequence or the recommendation information list via the user interface, to recognize a user emotion by executing an emotion recognition program that estimates an emotional state based on at least one of facial information, voice information, or operation history information of the user, and to adjust content or presentation order of the search term sequence or the recommendation information list in accordance with the recognized emotional state; and to update at least one of the generative AI model or a recommendation algorithm by using past behavior history data and attribute data of the user as learning data, thereby individually optimizing, based on the structured data, the emotional state, and the behavior history data, at least one of a prompt sentence generated in a subsequent process and generated result data of related information. This enables the computing system to more efficiently utilize processing and communication resources by limiting analysis to user-specified regions of interest, to generate higher-quality and contextually accurate search terms and recommendation lists by using unified multi-modal structured data and generative AI prompts, to adapt output content in real time based on recognized user emotion, and to continuously refine generative and recommendation behavior through behavior-history-driven model updates, thereby improving the overall technical performance of information retrieval and recommendation on the computing platform.

The term “system” refers to an assembly of hardware, software, and network components that cooperatively perform information processing and user interaction functions as specified in the claims.

The term “processor” refers to one or more hardware computing units, such as central processing units or accelerator units, configured to execute instructions that implement the functions described in the claims.

The term “user interface” refers to a combination of hardware and software components that enable bidirectional interaction between a user and the system, including at least an input device and a display device.

The term “input device” refers to a hardware component that receives user operations, including but not limited to a touch-sensitive panel, a pointing device, a keyboard, or a gesture detection sensor.

The term “gaze detection device” refers to a sensing component that detects a direction or position of a user's line of sight relative to a display surface and outputs information indicative of a gaze position.

The term “display device” refers to a hardware component that visually presents information to a user, such as a flat-panel display, a head-mounted display, or a projection display.

The term “information data” refers to digital data that represents content such as text, graphics, images, audio, or video that is capable of being displayed by the display device.

The term “image data” refers to digital data representing a still image or a single frame of a moving image that can be processed by an image processing program or a machine learning model.

The term “imaging device” refers to a hardware component that acquires image data from a physical scene, such as a digital camera, an image sensor module, or a video capture device.

The term “region of interest” refers to a portion of information data or image data that is specified by the user, directly or indirectly, as a target for analysis or retrieval processing.

The term “position information” refers to data indicative of a spatial location or extent of the region of interest within a coordinate system, including at least coordinates, a bounding region, or an element identifier.

The term “content data” refers to data corresponding to the region of interest, including at least textual data, pixel data, or associated metadata extracted by the system.

The term “text data” refers to data in a character-based format, including words, phrases, or sentences, that can be processed by a natural language processing program.

The term “image data” (in the context of classification) refers to non-textual visual data associated with the region of interest that is suitable for processing by an image processing program or a machine learning model.

The term “natural language processing program” refers to software that analyzes text data using computational linguistic methods, including but not limited to tokenization, part-of-speech tagging, named entity extraction, and topic extraction.

The term “tokenization” refers to a processing step that segments text data into smaller units such as words, subwords, or symbols for subsequent analysis.

The term “part-of-speech tagging” refers to a processing step that assigns grammatical category labels to tokens in text data, such as noun, verb, adjective, or adverb.

The term “named entity extraction” refers to a processing step that detects and classifies specific expressions in text data, such as names of persons, organizations, locations, or other identifiable entities.

The term “topic extraction” refers to a processing step that determines one or more abstract themes, subjects, or categories that characterize the content of text data.

The term “image processing program” refers to software that analyzes or transforms image data by executing operations such as detection, segmentation, or feature computation.

The term “machine learning model” refers to a computational model that has been trained using data to perform tasks such as classification, detection, or prediction without being explicitly programmed for each specific instance.

The term “object detection” refers to a processing operation that identifies and localizes one or more objects of interest within image data, typically outputting object class labels and associated regions.

The term “face detection” refers to a processing operation that identifies and localizes human faces within image data, typically returning positions or regions corresponding to detected faces.

The term “region extraction” refers to a processing operation that isolates a portion of image data associated with a detected object, area, or feature for further analysis.

The term “feature calculation” refers to a processing operation that computes numerical descriptors or representations of text data or image data, which are usable for tasks such as similarity computation, classification, or clustering.

The term “structured data” refers to data organized according to a predefined schema or format, including fields such as entity identifiers, categories, attributes, and relationships representing user intention or user interest.

The term “user intention” refers to an inferred purpose, goal, or information need of the user in relation to the region of interest.

The term “user interest target” refers to an inferred entity, object, topic, or concept within the region of interest that is determined to be the focus of the user's attention.

The term “related information candidate” refers to an item of information, such as a record or document, retrieved from a database or index based on similarity or relevance to the structured data.

The term “related information candidate database” refers to a data storage structure that holds records of information items that can be retrieved as candidates for recommendation or explanation.

The term “search index” refers to a data structure that enables efficient retrieval of information items based on keys, terms, or features derived from content data.

The term “prompt sentence” refers to a sequence of natural language text, optionally combined with structured tokens, that is provided as input to a generative AI model to specify a task, context, or desired output format.

The term “generative AI model” refers to a trained computational model that generates text or other data outputs based on an input such as a prompt sentence, using techniques including probabilistic modeling or neural network architectures.

The term “generated result data” refers to data output by the generative AI model in response to a prompt sentence, including at least explanatory text or recommendation information.

The term “explanatory text” refers to natural language output that provides a description, summary, or explanation of related information derived from analysis and generative processing.

The term “recommendation information” refers to data that suggests one or more information items, actions, or options to the user, based on structured data and model outputs.

The term “search term sequence” refers to an ordered collection of terms or phrases constructed for use as a query or input to an information retrieval process.

The term “recommendation information list” refers to an ordered collection of recommendation information elements, each associated with at least one related information candidate.

The term “emotion recognition program” refers to software that estimates a user's emotional state based on input signals such as facial information, voice information, or interaction patterns.

The term “user emotion” refers to an estimated affective state of the user, such as satisfaction, interest, frustration, or boredom, derived from analysis of user-related signals.

The term “facial information” refers to data representing a user's facial appearance or expressions, obtained for example from image data or video frames.

The term “voice information” refers to audio data representing spoken sounds or speech uttered by the user, including acoustic characteristics used for emotion estimation.

The term “operation history information” refers to data representing a sequence or pattern of user interactions with the user interface, such as clicks, taps, scrolling, or time spent on elements.

The term “content or presentation order” refers to at least one of the selection, arrangement, layout, or ordering of items within the search term sequence or the recommendation information list.

The term “behavior history data” refers to accumulated data about past user interactions, including access history, selection history, and stay time information.

The term “attribute data” refers to data representing characteristics of a user, such as demographic information, device type, or preference indicators.

The term “recommendation algorithm” refers to a computational procedure that selects or ranks related information candidates for presentation to the user based on structured data, behavior history data, or model outputs.

The term “individual optimization” refers to adaptation or tuning of system behavior, including generation of prompt sentences and generated result data, to match characteristics or preferences of a particular user.

The term “access history” refers to a subset of behavior history data indicating which information items or services the user has previously accessed.

The term “selection history” refers to a subset of behavior history data indicating which items the user has actively selected or engaged with among presented options.

The term “stay time information” refers to temporal data indicating durations for which a user remains on or interacts with particular content or interface elements.

In one embodiment, a server cooperates with one or more terminals operated by a user to implement the claimed system. The server and the terminals are connected via a communication network such as the Internet using a protocol such as HTTPS. The server includes at least one processor, a memory storing programs and data structures, and one or more storage devices holding content indexes, user logs, and model parameters. The terminal includes at least one processor, a memory, a display device such as a flat-panel display or head-mounted display, an input device such as a touch panel or pointing device, and, in some cases, a gaze detection device and an imaging device such as a camera. The terminal executes an application (for example, a web browser or native application) that renders information data such as text, images, and video frames received from the server. The terminal further executes a user interface control module that tracks user interactions. When the user taps, clicks, or performs a gesture on a portion of the displayed content, or when the user's gaze is detected at a specific region by the gaze detection device, the terminal identifies this region as a region of interest. The terminal generates position information such as coordinates on the display, bounding rectangles, or identifiers of corresponding document elements, and also acquires content data from the region of interest, such as textual content, pixel data, or metadata.

The server receives the position information and content data from the terminal and stores them in memory as a structured record. The server uses a data structure in which each record includes fields such as user identifier, session identifier, region coordinates, content type, raw text data, image data reference, and a timestamp. By organizing the data in this manner, the server can efficiently pass the relevant content data to specialized processing modules and avoid loading or analyzing entire documents or images that are not part of the selected region of interest. This reduces input/output overhead and processing time compared to conventional systems that operate on entire pages or entire images. The server classifies the content data into text data and image data. For text data, the server executes a natural language processing program implemented using a library such as spaCy or NLTK. The processor of the server loads the text data into a token buffer and applies tokenization rules based on character patterns and language models, thereby segmenting the text into tokens. The server then applies part-of-speech tagging using a trained sequence labeling model to assign grammatical categories to each token. The server further applies named entity recognition models to detect named entities such as persons, locations, and organizations, and applies topic extraction algorithms such as latent Dirichlet allocation or neural topic modeling to infer one or more topics associated with the text.

For image data, the server executes an image processing program implemented using a library such as OpenCV, optionally combined with deep learning frameworks such as PyTorch or TensorFlow. The server uses a convolutional neural network model for object detection and face detection. In one example, the server deploys a neural network architecture with multiple convolutional layers, pooling layers, and fully connected layers, trained on large-scale image datasets to recognize a variety of object categories and facial patterns. The server feeds the cropped image region or a scaled version of the region of interest into the neural network, obtains feature maps, and decodes bounding boxes and class probabilities to detect objects and faces. The server then performs region extraction by cropping subregions around detected objects and calculates feature vectors such as deep embeddings or handcrafted descriptors that capture visual characteristics of the region.

The server integrates the text analysis results and image analysis results into a unified structured data representation. The server uses a schema that includes fields for extracted entities, topics, object labels, face identities (if available), and associated confidence scores. The server may employ a graph-based representation in which entities and objects are nodes and relations between them (such as “appears in,” “is part of,” or “is about”) are edges. By unifying the results into such structured data, the server can perform subsequent retrieval and recommendation computations on a compact and semantically rich representation instead of unstructured raw data, thereby improving the efficiency and accuracy of downstream algorithms.

The server queries a related information candidate database or a search index by using the structured data as input. The server maps entities, topics, and object labels to indexing terms and uses an information retrieval engine to retrieve candidate records such as documents, media items, or reference entries. The server may compute relevance scores using feature-based ranking functions that combine text similarity (for example, cosine similarity in a vector space), visual similarity (for example, distance between image feature vectors), and contextual signals derived from the structured data. The server retains a subset of high-scoring related information candidates for further processing.

The server constructs a prompt sentence for a generative AI model by combining the structured data and the related information candidates. The server uses a prompt generation module that assembles natural language instructions based on predefined templates and dynamically inserted content fields. For example, if the structured data includes an actor entity extracted from an image region, and the related information candidates include motion pictures associated with that actor, the server may generate the following prompt sentence:

“The user has selected the face of an actor in a video frame. Detected actor name: ‘[Actor Name]’. Based on this actor, generate a list of 5 recommended movies starring this actor, each with a 1-2 sentence description and release year. Then add a short paragraph (within 120 words) explaining why these movies might interest a viewer who liked the original trailer.”

In another example, if the structured data includes a technical term extracted from a text region, the server may generate a prompt sentence such as:

“The user highlighted the text: ‘[Technical Term]’. Explain this concept in simple terms for a non-expert reader, and then suggest 3 related topics the user might want to explore next, with one-sentence descriptions for each.”

The server transmits the prompt sentence and, optionally, additional structured metadata to a generative AI model. The generative AI model may be implemented as a transformer-based neural network deployed on the server or on a separate model-serving node. In one embodiment, the generative AI model comprises multiple self-attention layers, feed-forward layers, and layer normalization components, trained on large text corpora using an objective such as next-token prediction or masked language modeling. The server stores the model parameters, including weight matrices for attention and feed-forward layers, in specialized memory associated with a graphics processing unit or accelerator.

The server executes the generative AI model by feeding the prompt sentence as a sequence of token identifiers, applying embedding layers to convert tokens into vectors, and propagating the vectors through successive transformer blocks. During generation, the server computes probability distributions over possible next tokens at each step, selects tokens according to a decoding strategy such as beam search or nucleus sampling, and forms generated result data as a sequence of tokens that is then decoded to natural language text. The server may also embed control tokens or tags in the prompt sentence to instruct the model to produce outputs in certain formats or with certain length constraints.

The server receives the generated result data and parses the text to extract explanatory text and recommendation information. The server may apply post-processing rules to ensure coherence and to align named items in the generated text with actual records in the related information candidate database. By using the structured data and retrieved candidates as context for the generative AI model, the server reduces the need for the model to hallucinate or guess information, which improves accuracy and reduces the rate of incorrect or irrelevant outputs.

The server generates a search term sequence and/or a recommendation information list based on the generated result data. The server extracts key phrases from the generated text, identifies references to specific items, and orders them based on estimated relevance or user preference signals. The server then sends the search term sequence or recommendation information list to the terminal, which displays the results alongside or overlaid on the original content. The user can select any of the suggested terms or recommended items to navigate to further details.

The server also recognizes user emotion by executing an emotion recognition program. The terminal may capture facial information via the imaging device and voice information via a microphone, and may log operation history information describing interaction patterns such as rapid scrolling, frequent dismissals, or prolonged attention. The server receives these data and applies an emotion estimation algorithm. In one example, the server uses a neural network model that inputs facial feature vectors extracted by a convolutional network and acoustic features extracted from voice data, and outputs an estimated emotional state such as positive, neutral, or negative. The server may also use statistical models to infer frustration or interest from operation history patterns.

The server adjusts the content or presentation order of the search term sequence and recommendation information list according to the recognized emotional state. For instance, if the emotion recognition program estimates that the user is frustrated, the server may suppress complex or low-confidence recommendations and prioritize concise explanations with high confidence scores. If the user appears highly engaged, the server may expand the number of recommended items and include more exploratory suggestions. Because the adjustment is performed automatically by the server based on quantitative emotion estimates and structured data, the system can adapt output in real time in a way that is not achievable by manual human operation.

The server further updates at least one of the generative AI model or the recommendation algorithm based on behavior history data and attribute data. The server records access history, selection history, and stay time information as individual events associated with user identifiers. Periodically or on demand, the server uses these logs to fine-tune the generative AI model or to retrain ranking models. For generative model adaptation, the server may select training samples in which prompt sentences and subsequent user selections are known, and may further train the transformer network using a loss function that penalizes outputs that were associated with low user engagement. For recommendation algorithm adaptation, the server may train a supervised ranking model using features derived from structured data, emotional state estimates, and historical outcomes.

By performing such adaptive learning, the server modifies parameters of the neural networks and recommendation algorithms so that future prompt sentences and generated result data better match user preferences and interaction patterns. This yields a measurable improvement in the accuracy of recommendations, reduces the need for repeated or redundant server-client communication, and minimizes unnecessary processing of low-value content.

In another embodiment, the server employs alternative model architectures or processing pipelines while retaining the same functional configuration. For example, the server may use a recurrent neural network or a hybrid transformer-recurrent network instead of a purely transformer-based generative AI model. The server may also use alternative topic extraction techniques such as non-negative matrix factorization instead of probabilistic models. Similarly, the emotion recognition program may use support vector machines, decision trees, or ensemble methods trained on multimodal features instead of deep neural networks.

The terminal can also vary in form. In one embodiment, the terminal is a smartphone equipped with a capacitive touch screen and a front-facing camera used for both video capture and facial expression analysis. In another embodiment, the terminal is a head-mounted display with integrated gaze detection and inertial sensors, where the user specifies the region of interest by gaze fixation. In yet another embodiment, the terminal is a desktop computer with a mouse and keyboard as input devices and a separate camera for image acquisition and emotion recognition.

The system as a whole provides technical improvements over conventional systems. Because the server processes only the user-specified region of interest and uses compact structured data rather than entire documents or images, the server reduces central processing unit load, memory consumption, and network bandwidth usage. Multi-modal integration into structured data allows the server to generate more precise prompt sentences and reduces the amount of trial-and-error calls to the generative AI model, improving computation efficiency and response latency. Emotion-aware adjustment of outputs prevents the server from repeatedly transmitting unhelpful information, thereby decreasing wasted communication and processing. Continuous personalization through behavior-history-based learning leads to better alignment between server outputs and user needs, reducing the number of interactions required to reach desired information and lowering the cumulative computational cost.

The server thus does not merely automate a human task such as reading and searching but restructures the internal data representations and processing sequence to exploit machine-specific capabilities, such as large-scale parallel computation in neural networks, multi-modal feature fusion, and dynamic model adaptation based on streaming logs. These technical features, taken together, enhance the functioning of the computer system itself by providing faster, more accurate, and more resource-efficient context-sensitive information retrieval and recommendation than was practically achievable with prior architectures.

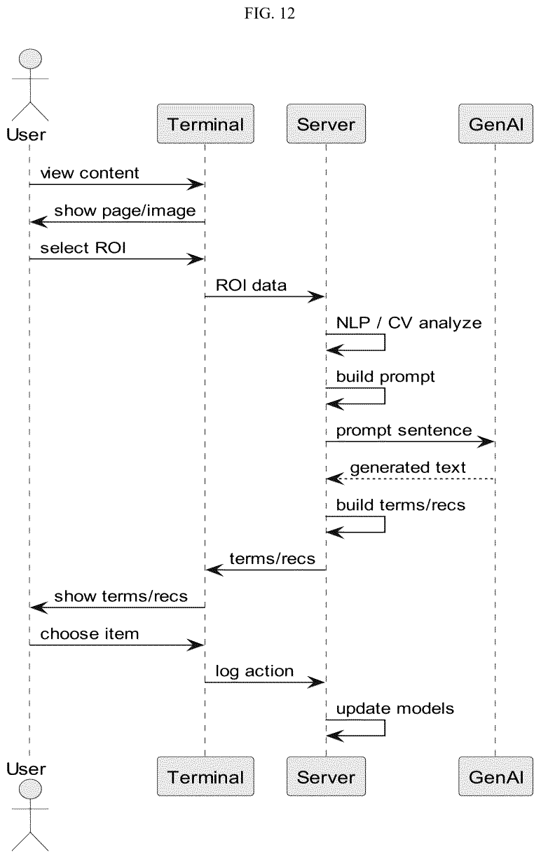

The following describes the processing flow using FIG. 12.

### Step 1:

The terminal displays information data on a display device.

The terminal receives, as input, content data from the server, such as HTML, JSON, image files, and video streams, and renders this data using a browser engine or a native rendering component. The terminal converts encoded data (for example, compressed image bytes or video frames) into pixel data and draws text, images, and video frames onto the screen.

The output of this step is a visual presentation of information data that the user can view and interact with.

### Step 2:

The user specifies a region of interest on the terminal.

The user provides, as input, an operation such as a tap, click, drag gesture, or a gaze fixation on a particular area of the displayed content. The terminal detects this operation through event listeners in the user interface framework and calculates coordinates or a bounding rectangle corresponding to the region of interest. The terminal may also obtain metadata such as the identifier of a document element under the pointer or gaze. The output of this step is region-of-interest information including position data and a reference to the underlying content.

### Step 3:

The terminal acquires content data corresponding to the region of interest.

The terminal receives, as input, the region-of-interest information from Step 2 and accesses the underlying content buffer (for example, a DOM tree, an image frame buffer, or a video frame cache). The terminal extracts text segments, pixel regions, or associated metadata that fall within the region of interest by slicing the relevant buffers based on the position data. The terminal may generate a cropped image matrix or a substring of text. The output of this step is content data associated with the region of interest, including text data, image data, or both.

### Step 4:

The terminal transmits the region-of-interest data to the server.

The terminal receives, as input, the position data and content data generated in Step 3, and packages them into a structured payload that includes fields such as user identifier, session identifier, content type, coordinates, raw text snippet, and an encoded image segment if present. The terminal serializes this payload into a data format such as JSON or protocol buffers and sends it to the server via an HTTP or HTTPS POST request. The output of this step is a network message containing the region-of-interest data delivered to the server.

### Step 5:

The server stores and classifies the received region-of-interest data.

The server receives, as input, the payload sent by the terminal in Step 4. The server parses the payload, validates required fields, and writes the data into an internal data structure or database record with defined fields for text data, image data reference, and metadata. The server then examines the content type flags and the presence of text and image fields to classify the data into text data, image data, or multi-modal data. The output of this step is a classified region-of-interest record stored in memory or a database and ready for analysis.

### Step 6:

The server performs natural language processing on text data.

The server receives, as input, text data from the classified record of Step 5. The server uses a natural language processing library to tokenize the text into tokens, apply part-of-speech tagging, and perform named entity extraction and topic extraction. The server executes algorithms that map character sequences to tokens, apply trained sequence models to assign grammatical tags, and identify entity spans and topic distributions. The output of this step is a set of structured text features, including token lists, tagged tokens, named entities, and inferred topics with confidence scores.

### Step 7:

The server performs image analysis on image data.

The server receives, as input, image data from the classified record of Step 5, such as a cropped image matrix or an encoded image segment. The server decodes the image if necessary and resizes it to a standard resolution. The server then applies an image processing program or a deep learning model, such as a convolutional neural network, to detect objects and faces and to extract image features. The server computes feature maps, identifies bounding boxes with class labels, and generates feature vectors that represent visual characteristics. The output of this step is a set of structured image features, including object labels, face detection results, regions, and feature vectors.

### Step 8:

The server integrates text features and image features into structured data.

The server receives, as input, the structured text features from Step 6 and the structured image features from Step 7. The server aligns entities and objects based on semantic similarity and context, for example by matching named entities to object labels or by correlating topics with detected scenes. The server constructs a unified representation such as a record or graph that includes fields for entities, topics, object types, relationships, and confidence scores. The server may merge redundant entries and normalize identifiers. The output of this step is structured data representing user intention or user interest target associated with the region of interest.

### Step 9:

The server retrieves related information candidates from storage.

The server receives, as input, the structured data generated in Step 8. The server maps entities, topics, and object labels to index terms and issues queries to a related information candidate database or a search index. The server computes similarity scores using text-based and feature-based ranking functions and retrieves candidate records such as articles, media items, or reference entries. The server selects a subset of candidates with the highest relevance scores. The output of this step is a list of related information candidates with associated metadata and relevance values.

### Step 10:

The server generates a prompt sentence for a generative AI model.

The server receives, as input, the structured data from Step 8 and the related information candidates from Step 9. The server applies a prompt generation module that assembles a natural language instruction by filling templates with dynamic fields such as entity names, topics, and candidate item summaries. The server may insert constraints about the number of items, output length, or style. As a result, the server produces a prompt sentence that clearly specifies the generative task. The output of this step is a prompt sentence ready to be input to a generative AI model.

### Step 11:

The server invokes the generative AI model using the prompt sentence.

The server receives, as input, the prompt sentence from Step 10. The server encodes the prompt sentence into tokens using a tokenizer associated with a transformer-based generative AI model. The server loads token embeddings and processes them through multiple self-attention and feed-forward layers to compute context-aware hidden states. The server then performs decoding using a method such as beam search or sampling to generate a sequence of output tokens. The server finally decodes the tokens into text. The output of this step is generated result data including explanatory text and recommendation information.

### Step 12:

The server post-processes the generated result data into search terms and recommendations.

The server receives, as input, the generated result data from Step 11. The server analyzes the text to identify key phrases, item names, and descriptive segments using pattern matching and natural language parsing. The server associates referenced items with actual records in the related information candidate database when possible. The server then constructs a search term sequence by selecting and ordering key phrases and constructs a recommendation information list by enumerating recommended items with their attributes. The output of this step is a structured representation of search terms and recommendation entries.

### Step 13:

The server recognizes user emotion using multimodal signals.

The server receives, as input, user-related signals such as facial information, voice information, and operation history information collected by the terminal and transmitted to the server. The server extracts features from facial images (for example, facial landmarks or expression vectors) and from voice data (for example, pitch, energy, and spectral features), and computes interaction features from operation logs (for example, frequency of dismissals or dwell times). The server inputs these features into an emotion recognition model, such as a neural network or a statistical classifier, and obtains an estimated emotional state with confidence scores. The output of this step is a recognized user emotion state that can be used to adapt presentation.

### Step 14:

The server adjusts the content and presentation order of outputs based on emotion.

The server receives, as input, the search term sequence and recommendation information list from Step 12 and the recognized user emotion from Step 13. The server applies adjustment rules that modify the list length, reorder items, or filter out certain categories depending on the emotional state. For example, the server may down-rank exploratory items when the user appears frustrated and prioritize concise, high-confidence recommendations. The server computes a new ordering and optionally prunes entries. The output of this step is an emotion-adjusted search term sequence and recommendation information list.

### Step 15:

The server returns the adjusted search terms and recommendations to the terminal.

The server receives, as input, the adjusted search term sequence and recommendation information list from Step 14. The server serializes these data into a response format such as JSON, including fields for terms, item titles, summaries, and links. The server sends the response back to the terminal via an HTTP or HTTPS response. The output of this step is a response message containing the adjusted outputs available to the terminal.

### Step 16:

The terminal presents the search term sequence and recommendation information list to the user.

The terminal receives, as input, the response message from Step 15. The terminal parses the structured data and creates user interface elements such as lists, buttons, or cards that display the search terms and recommendation items. The terminal arranges these elements on the display, for example in a side panel or overlay near the original region of interest. The user can visually identify the suggested terms and recommendations. The output of this step is a visual presentation of search and recommendation results on the terminal.

### Step 17:

The user interacts with presented search terms and recommendations.

The user receives, as input, the displayed search terms and recommendation items and may tap or click on one of the items to request more detail or navigate to related content. The terminal detects the user selection and updates its interface state. The output of this step is a new user interaction event that can trigger additional content requests or further analysis cycles.

### Step 18:

The server logs behavior history data for model adaptation.

The server receives, as input, user interaction events from Step 17, including which search terms or recommendations were selected, the time of interaction, and the duration of subsequent content viewing. The server writes these events into a behavior history log, associating them with user identifiers and session identifiers. The server may also compute aggregate statistics such as click-through rates or dwell times. The output of this step is updated behavior history data stored for learning.

### Step 19:

The server updates model parameters using behavior history and attribute data.

The server receives, as input, the accumulated behavior history data from Step 18 and attribute data for the user population. The server selects training examples that pair prompt sentences, structured data, and user responses (for example, selections or non-selections). The server uses these examples to fine-tune the generative AI model or to retrain recommendation algorithms by computing a loss function that measures the discrepancy between predicted and observed user actions and then adjusting model parameters using optimization algorithms such as gradient descent. The output of this step is updated model parameters that will influence future prompt sentence generation and recommendation behavior.

### Step 20:

The server and the terminal continue the cycle for subsequent regions of interest.

The server receives, as input, any new region-of-interest data and updated model parameters, and the terminal receives improved outputs for subsequent user interactions. The system reuses the optimized models and structured data representations so that later executions of Steps 1 through 19 are faster and more accurate. The output of this step is an improved, adaptive interaction loop in which subsequent processing benefits from prior computations and learning.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval systems and user interfaces for accessing digital content generally rely on manual entry of search queries by a user. In these systems, a user typically reads an article or other content, mentally identifies a concept of interest, switches context to a search interface, and then formulates and refines one or more search terms. This process imposes a cognitive burden on the user and often results in incomplete or suboptimal queries, particularly when the user lacks domain knowledge or does not know which terms are effective for retrieving detailed information. Furthermore, in many existing systems, natural language processing components are implemented as static keyword extraction engines that do not effectively leverage modern generative models. Such systems generally do not integrate structured user behavior data, user interest attributes, or user emotional state into the generation and ranking of search terms. As a result, the system fails to adapt search suggestions to the specific context and psychological state of the user at the time of interaction, and cannot dynamically optimize the search process based on real-time user needs.

In addition, although generative AI models can generate rich natural language outputs, they are often invoked in an ad hoc manner, with prompt sentences being manually crafted by developers or users. Existing architectures do not provide a systematic mechanism in which a computing system automatically constructs prompt sentences from fine-grained user-selected text, extracted linguistic features, and user profile information, and uses the resulting outputs to iteratively refine structured search term sets. This leads to inefficient utilization of computational resources and under-utilization of the capabilities of generative AI models within an integrated retrieval workflow.

From the standpoint of computer technology, the above limitations manifest as increased latency and processing overhead in user-system interaction cycles, poor utilization of available processing components across client and server devices, and a lack of coordinated control logic that combines deterministic natural language processing with probabilistic generative models. The absence of a unified control flow for (i) capturing user-selected regions of interest in displayed content, (ii) executing multi-stage linguistic analysis and model-based generation of search candidate terms, and (iii) adapting the presentation and ranking of the terms to a detected user emotional state, results in a suboptimal human-computer interface and reduced system-level efficiency.

Accordingly, there is a need for a technical solution that improves the functioning of a computer system by providing an integrated mechanism to: (1) automatically convert user-selected regions of interest in displayed content into structured text data with associated context and user identifiers; (2) perform layered linguistic processing to extract feature terms; (3) construct and issue optimized prompt sentences to a generative information processing model; (4) integrate and filter both deterministic and generative candidate search terms; and (5) adjust the weighting and display order of search terms based on an estimated emotional state of the user. Such a solution should reduce the cognitive and operational load on the user while improving the precision and relevance of search suggestions and the efficiency of the overall computation pipeline.

The specific processing by the specific processing unit 290 of the data processing device 12 in Example 2 is realized by the following means.

The present invention provides a server comprising at least one processor and at least one memory storing instructions that, when executed by the at least one processor, cause the server to receive, from a terminal device via a communication interface, text data corresponding to a region of interest designated by a user within information data presented on the terminal device, together with user identification information and attribute information of the information data; to perform, by using natural language processing software, linguistic analysis including at least morphological analysis, syntactic analysis, and semantic analysis on the text data to extract feature terms; to read, from a storage device, past user behavior data associated with the user identification information and to generate user attribute information including at least interest attributes and preference attributes based on the past user behavior data; to generate, based on the feature terms and the user attribute information, a plurality of deterministic search candidate terms for acquiring related information; to construct a prompt sentence that includes at least the feature terms and the user attribute information as input information to a generative information processing model, and to transmit the prompt sentence to the generative information processing model to cause the generative information processing model to generate a group of generative search candidate terms; to integrate the plurality of deterministic search candidate terms with the group of generative search candidate terms, to remove duplicate and irrelevant terms from the integrated terms, and to determine a final set of search terms; to estimate, by a user state estimation engine, an emotional state of the user based on at least one of biometric information and behavior history information of the user; to adjust at least one of weighting and ranking of the search terms included in the final set of search terms according to the estimated emotional state; and to transmit, to the terminal device, the adjusted final set of search terms to be presented via a user interface and to enable the terminal device, in response to a selection of at least one of the search terms by the user, to execute at least one of an external information search process and a process of generating and transmitting an additional prompt sentence to the generative information processing model. This enables an improvement in the functioning of the computer system by providing an integrated and adaptive information retrieval pipeline that automatically transforms user-selected content into context-aware and emotion-aware search suggestions, optimizes the use of deterministic and generative processing resources, reduces user interaction steps, and enhances the efficiency and relevance of information access.

The term “system” refers to a combination of one or more computing devices, including at least a server and optionally one or more terminal devices, configured to execute the processing described in the claims as a coordinated whole.

The term “processor” refers to one or more hardware processing units, such as a central processing unit or a graphics processing unit, that execute machine-readable instructions to perform the functions recited in the claims.

The term “memory” refers to one or more hardware storage components, such as volatile memory or non-volatile memory, configured to store machine-readable instructions and data for use by the processor.

The term “terminal device” refers to an information processing apparatus operated by a user, such as a general-purpose computer, a portable communication device, or a display-equipped electronic device, that presents information data and receives input from the user.

The term “server” refers to an information processing apparatus, typically remote from the terminal device, that includes the processor and memory and performs centralized processing, analysis, and control functions over a communication network.

The term “user interface” refers to a combination of hardware and software components, such as a display, input devices, and graphical or textual interface elements, through which the user views information and performs operations including selection of a region of interest and selection of search terms.

The term “information data” refers to digital content presented to the user, including but not limited to text data, image data, or combined multimedia data, that can be rendered as visual information on a display of the terminal device.

The term “visual information” refers to information data that is rendered in a human-perceivable form on a display device, including text, images, graphics, and other display elements.

The term “region of interest” refers to a portion of the information data, such as a substring of text or a subarea of an image, that is explicitly designated by the user as being of particular interest for further analysis or retrieval.

The term “text data corresponding to the region of interest” refers to a character string, token sequence, or equivalent textual representation extracted from the information data based on the region of interest designated by the user.

The term “user identification information” refers to data that uniquely or pseudo-uniquely associates operations and behavior with a particular user, such as a user identifier, account identifier, or session identifier.

The term “attribute information of the information data” refers to metadata describing the information data, including at least one of a source identifier, a category, a language, a creation time, or a content type.

The term “communication interface” refers to hardware and software components that enable data transmission between the server and the terminal device over a communication network, such as wired or wireless network adapters and associated communication protocols.

The term “natural language processing software” refers to one or more software modules configured to analyze text data in a human language and to output structured information such as tokens, part-of-speech tags, syntactic structures, or semantic representations.

The term “morphological analysis” refers to a natural language processing operation that segments text data into minimal units such as words or morphemes and assigns linguistic attributes such as part-of-speech or inflectional form.

The term “syntactic analysis” refers to a natural language processing operation that identifies grammatical relationships between words or phrases in text data, such as dependency relations or phrase structures.

The term “semantic analysis” refers to a natural language processing operation that interprets the meaning of text data, including identifying entities, concepts, and semantic relations between elements within the text.

The term “feature terms” refers to words, phrases, or other textual units extracted from the text data and associated analysis results that are determined to be salient or representative for use in search, recommendation, or prompt construction.

The term “storage device” refers to one or more hardware units, such as magnetic storage, solid-state storage, or distributed storage systems, configured to store data including past user behavior data and user attribute information.

The term “past user behavior data” refers to data records indicative of historical actions of the user, including at least one of past content selections, search queries, click operations, browsing history, or interaction logs.

The term “user attribute information” refers to data representing characteristics inferred or determined for the user based on the past user behavior data, including at least interest attributes and preference attributes.

The term “interest attributes” refers to information representing topics, domains, or categories toward which the user has shown repeated or strong engagement, derived from analysis of the past user behavior data.

The term “preference attributes” refers to information representing patterns or tendencies of the user with respect to style, depth, or type of information preferred, derived from analysis of the past user behavior data.

The term “search candidate terms” refers to text strings or structured query elements generated for use as candidate search queries for retrieving related information from an external resource or internal database.

The term “deterministic search candidate terms” refers to search candidate terms generated by rule-based or algorithmic processing that does not involve non-deterministic generative models, based on inputs such as the feature terms and the user attribute information.

The term “generative search candidate terms” refers to search candidate terms produced as output from a generative information processing model in response to a prompt sentence that includes feature terms, user attribute information, or other contextual data.

The term “related information” refers to information data, such as documents, records, or generated text, that is determined to be relevant or associated with the region of interest or with the search candidate terms.

The term “generative information processing model” refers to a parameterized computational model, such as a machine learning model or generative AI model, configured to generate text or other data outputs based on input data such as a prompt sentence.

The term “prompt sentence” refers to a structured textual input provided to the generative information processing model, including at least feature terms, user attribute information, or other contextual information, that instructs the model regarding a desired generation task.

The term “group of generative search candidate terms” refers to a collection of search candidate terms output by the generative information processing model in response to the prompt sentence.

The term “final set of search terms” refers to a collection of search terms determined by integrating the deterministic search candidate terms and the generative search candidate terms, and by filtering out duplicate or irrelevant terms according to predetermined criteria.

The term “user state estimation engine” refers to a processing module configured to estimate a state of the user, including at least an emotional state, based on input data such as biometric information or behavior history information.

The term “emotional state” refers to a state representing the user's affective condition, such as interest, frustration, curiosity, or satisfaction, inferred by the user state estimation engine from biometric information or behavior history information.

The term “biometric information” refers to data representing physiological or physical measurements associated with the user, such as heart rate, facial expression data, voice characteristics, or other sensor-derived signals.

The term “behavior history information” refers to data representing sequences or patterns of operations performed by the user over time, including at least click patterns, dwell times, page transition sequences, or interaction frequencies.

The term “weighting of the search terms” refers to assignment or adjustment of numerical or categorical importance values to individual search terms in the final set of search terms for purposes of ranking or selection.

The term “ranking of the search terms” refers to determining an order of the search terms in the final set of search terms based on one or more criteria, including weighting values and the estimated emotional state.

The term “external information search process” refers to a process in which at least one of the final set of search terms is used as a query to retrieve information from an external information resource, such as a search service, a database, or a knowledge base.

The term “additional prompt sentence” refers to a further prompt sentence constructed based on at least a selected search term, the region of interest, or updated context information, and transmitted to the generative information processing model for additional generation or explanation.

In one embodiment, a server cooperates with at least one terminal to implement the claimed system. The server includes at least one processor, at least one memory, a storage device, and a communication interface. The terminal includes at least one processor, at least one memory, a display unit, and one or more input devices such as a touch panel, a pointing device, or a keyboard.

The terminal displays information data, such as text content or mixed media content, on the display unit. The terminal uses an operating system graphical framework, for example, a text view component or a browser rendering engine, to render textual content and to allow the user to select a region of interest. The user selects a region of interest by performing an input operation such as a tap, a long press, or a drag gesture over the displayed text. The terminal acquires text data corresponding to the region of interest by using a text-selection interface provided by the operating system.

The terminal associates the acquired text data with user identification information and attribute information of the information data. The terminal stores the user identification information, for example, as a pseudonymous identifier, and obtains attribute information of the information data, such as a source identifier, a category, a language, and a time stamp. The terminal constructs an internal data structure containing the text data, the user identification information, and the attribute information, and prepares to transmit this structure to the server via the communication interface.

The server receives the text data, the user identification information, and the attribute information from the terminal through the communication interface. The server stores the received data in the storage device in association with a request identifier. The server uses natural language processing software, such as a linguistic analysis library or a neural-network-based language model, to analyze the text data. The server first performs morphological analysis to segment the text into tokens and to assign part-of-speech tags. The server then performs syntactic analysis, such as dependency parsing, to identify grammatical relations among words. The server further performs semantic analysis to detect entities, concepts, and semantic roles.

The server extracts feature terms from the analysis results by combining rule-based selection and statistical scoring. The server implements rule-based selection by designating as feature terms those tokens or noun phrases that are identified as named entities or domain-relevant nouns. The server also computes term scores using statistical measures, such as term frequency-inverse document frequency values, and selects additional feature terms based on threshold criteria. The server stores the extracted feature terms in the storage device in association with the request identifier.

The server reads past user behavior data from the storage device by using the user identification information received from the terminal. The server maintains data records that include, for example, identifiers of previously selected regions of interest, search queries previously issued, click events, and dwell times on retrieved results. The server processes the past user behavior data to generate user attribute information representing interest attributes and preference attributes. The server uses a feature-generation module to convert the behavior data into numeric feature vectors, such as counts of topics, frequencies of content categories, and statistics of query types.

In one embodiment, the server uses a trained neural network model to map these feature vectors to user attribute information. The server implements this model as a multi-layer neural network, such as a feedforward network or a transformer-based encoder, with parameters stored in the memory. The server applies the model to the feature vectors to output probability distributions over topics or categories that represent interest attributes, and continuous values that represent preference attributes such as preferred depth of explanation or preferred focus on people, events, or background. The server stores the user attribute information in the storage device, linked to the user identification information. The server generates deterministic search candidate terms based on the feature terms and the user attribute information. The server applies a template-based generator that combines feature terms with generic query templates. For example, when the text data contains a phrase corresponding to “Nobel Peace Prize in 2023,” the server uses templates such as “[entity] recipient name,” “[entity] reason for award,” or “[entity] background information,” and fills in the entity with the recognized year and prize category. The server ranks the deterministic search candidate terms using a scoring function that combines relevance scores derived from linguistic analysis and alignment scores derived from the user attribute information.

The server constructs a prompt sentence for a generative AI model based on the feature terms and the user attribute information. The server arranges the feature terms and user attributes into a structured natural language input. For example, the server may construct a prompt sentence such as: “From the phrase ‘2023 Nobel Peace Prize laureate’ and given that the user is strongly interested in international politics and human rights, generate 3 to 5 concise search queries that the user might use to obtain more detailed information.” In another example, the server may construct a prompt sentence such as: “Given the text ‘2023 Nobel Peace Prize laureate’ and a user preference for explanations of background and reasons, generate specific search terms focusing on the reasons for the award and the background of the laureate.”

The server provides the constructed prompt sentence to a generative information processing model. In one embodiment, the generative information processing model is implemented as a transformer-based neural network comprising a plurality of self-attention layers, feedforward layers, and layer-normalization components. The server stores model parameters, such as weight matrices and bias vectors, in a model storage region, and executes inference using a neural-network inference engine. The server tokenizes the prompt sentence using a subword tokenizer, maps tokens to embeddings, and processes the embeddings through the transformer layers to obtain output token probabilities. The server decodes the output tokens by applying sampling or beam search with constraints that encourage short, query-like outputs, thereby generating a group of generative search candidate terms.

The server integrates the deterministic search candidate terms and the generative search candidate terms. The server normalizes the terms by lowercasing, removing stopwords, and applying stemming or lemmatization. The server uses a similarity metric, such as cosine similarity between term embeddings, to identify duplicate or near-duplicate terms. The server removes terms that exceed a similarity threshold with already retained terms, and applies a relevance filtering rule to discard terms that lack key entities or that fall outside a domain boundary determined from the feature terms. The server determines a final set of search terms and stores the final set in the storage device.

The server estimates an emotional state of the user by using a user state estimation engine. The server receives biometric information and behavior history information from the terminal or from connected sensors. For example, the terminal may acquire camera-based facial expression features, voice prosody parameters from a microphone input, or heart rate data from a wearable sensor. The server processes this information using a neural-network-based emotion estimation module, such as a convolutional neural network for image-based features or a recurrent network for temporal signal features. The server maps the extracted features to an emotional state representation, such as a vector of probabilities over discrete states (e.g., interested, confused, frustrated) or continuous arousal and valence values.

The server adjusts the weighting and ranking of search terms in the final set based on the estimated emotional state. For example, when the emotional state indicates confusion, the server increases the weight of search terms that lead to explanatory or background information queries. When the emotional state indicates high interest and low frustration, the server may prioritize more specific, detailed search terms that match nuanced aspects of the feature terms. The server updates ranking scores by applying an adjustment function that takes as input the baseline scores and the emotional state values, and reorders the search terms accordingly.

The server transmits the adjusted final set of search terms to the terminal for presentation.

The terminal receives the search terms, constructs user interface elements such as selectable buttons or list entries, and displays them to the user. The user selects one of the presented search terms by performing an input operation. The terminal receives the selection and either initiates an external information search process or constructs an additional prompt sentence for the generative AI model. For example, the user may select a search term corresponding to “2023 Nobel Peace Prize award reason,” and the terminal may then construct a prompt sentence such as: “Explain in detail the reasons why the laureate received the 2023 Nobel Peace Prize.” The terminal transmits this prompt sentence to the server, and the server processes the prompt sentence by invoking the same or another generative information processing model to generate explanatory text, which is then returned to the terminal and displayed to the user.

In another embodiment, the server incorporates the deterministic generation, generative generation, and emotional adjustment into a unified pipeline that operates in an optimized manner to reduce processing time and communication load. The server caches intermediate results, such as feature terms and user attribute information, so that repeated selections within the same article or within a short time window do not require full recomputation. The server compresses the request and response payloads using a compact representation to reduce communication bandwidth requirements. The server executes neural-network inference on hardware accelerators, such as graphics processing units or specialized neural processing units, to increase processing speed. By structuring the processing pipeline to exploit both deterministic and generative components, the server reduces the number of generative model calls required for each user interaction, thereby decreasing computational cost and latency.

The described configuration improves computer technology in multiple ways. The server reduces cognitive and input burden on the user by transforming user-selected regions directly into optimized, context-aware search terms, thereby eliminating multiple manual query formulation steps. The server increases technical efficiency by using specific data structures, such as feature-term vectors, user attribute vectors, and emotional state vectors, and by combining them through defined algorithms, such as template-based generation, similarity filtering, and emotion-based ranking adjustment. The server improves the precision of search suggestions by integrating deterministic linguistic analysis with generative modeling, rather than simply automating human keyword creation. The server reduces communication and computation overhead by caching and reusing intermediate representations, by pruning redundant candidate terms, and by adaptive ranking that avoids unnecessary model calls.

In still another embodiment, the server uses alternative generative AI models, such as a sequence-to-sequence model with an encoder-decoder architecture or a recurrent neural network model, instead of or in addition to a transformer-based model. The server trains the generative model using historical logs of user-selected regions and successful search queries. During training, the server minimizes a loss function that measures the difference between generated candidate terms and actual user query terms, such as a cross-entropy loss over token sequences. The server updates model weights using gradient-based optimization algorithms, such as stochastic gradient descent with adaptive learning rate. The server may also perform data augmentation by permuting or paraphrasing training prompts and by adding noise to feature terms to improve robustness. By revealing details of model architecture and training procedures, this embodiment ensures that the generative AI model behavior is not purely abstract but grounded in specific computational mechanisms.

In yet another embodiment, the server employs alternative emotion estimation methods, such as a hybrid rule-based and machine-learning approach. The server may derive initial emotion scores from simple rules based on user behavior patterns, such as rapid repeated selections or frequent backtracking, and then refine these scores using a trained classifier. The server adjusts the search-term ranking algorithm to emphasize simplicity and redundancy reduction in states correlated with frustration. By implementing these non-conventional rules and combining them with learned models, the system performs processing that differs from ordinary human reasoning and from simple human task automation.

The overall architecture can be implemented in various deployment models. In one variation, the generative AI model resides on an external service, and the server acts as a proxy that constructs prompt sentences, sends them to the external service, and receives generated search candidate terms. In another variation, the generative AI model is locally deployed on the same hardware as the server, allowing reduced latency and local control of model parameters. In both cases, the server coordinates deterministic analysis, generative generation, emotional-state estimation, and ranking adjustment to provide a coherent, technically efficient pipeline for context-aware and emotion-aware information retrieval.

Through these embodiments and variations, the server, the terminal, and the cooperating components implement the claimed system in a way that is concrete, reproducible, and technically advantageous, improving processing speed, precision of search suggestions, computational efficiency, and management of user-related data beyond mere automation of human mental processes.

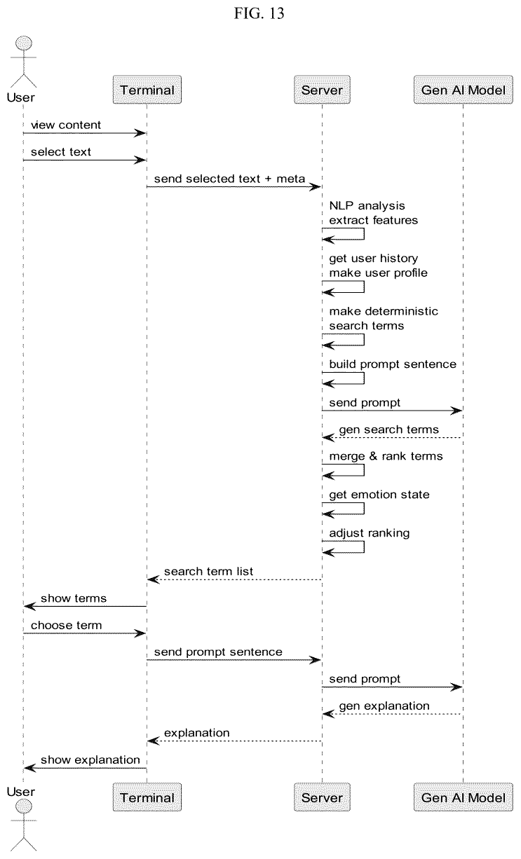

The following describes the processing flow using FIG. 13.

### Step 1:

The user views information data on the terminal. The terminal receives, as input, digital content data from a content source or server (for example, an article containing text). The terminal processes this input by rendering the text using an operating system text component or browser engine, and outputs visual information on a display so that the user can see sentences, paragraphs, and other elements of the content.

### Step 2:

The user selects a region of interest in the displayed content. The terminal receives, as input, user interaction events such as touch coordinates, mouse drag positions, or key-based selection commands over the displayed text. The terminal processes these events by mapping the screen coordinates to character offsets within the rendered content, extracting the corresponding substring as text data, and outputs the selected text string together with internal metadata such as a content identifier and a time stamp.

### Step 3:

The terminal associates the selected text with user and content attributes. The terminal receives, as input, the selected text string from Step 2, a stored user identification value, and attribute information of the information data (for example, source URL, language code, and category label). The terminal processes these inputs by constructing a structured record (for example, a key-value map) that includes fields for selected_text, user_id, and content_attributes, and outputs this structured record as a request payload.

### Step 4:

The terminal transmits the structured record to the server. The terminal receives, as input, the structured record generated in Step 3. The terminal processes this input by serializing the record into a network-transmittable format, such as a JSON string, encapsulating it into an HTTP or HTTPS request, and outputting the request via a communication interface to the server.

### Step 5:

The server receives and stores the request data. The server receives, as input, the HTTP or HTTPS request from the terminal containing the JSON payload. The server processes this input by parsing the HTTP headers and body, decoding the JSON string into an internal data object with fields for text data, user identification information, and attribute information, assigning a request identifier, and outputting the parsed object while storing it in a storage device for later reference.

### Step 6:

The server performs linguistic pre-processing on the selected text. The server receives, as input, the text data field from the parsed object of Step 5. The server processes this input by applying natural language processing software to perform tokenization, normalization (such as lowercasing and punctuation removal, where appropriate), and language verification. The server outputs a sequence of tokens and associated basic linguistic features, such as token positions and part-of-speech tags.

### Step 7:

The server performs syntactic and semantic analysis to extract feature terms. The server receives, as input, the token sequence and basic features from Step 6. The server processes these inputs by running syntactic parsing (for example, dependency parsing) to identify grammatical relations and by running semantic analysis components such as named-entity recognition to detect entities and key phrases. The server applies rule-based filters and statistical scoring over these analysis results to identify salient entities and noun phrases, and outputs a list of feature terms, each annotated with relevance scores and linguistic labels.

### Step 8:

The server retrieves and converts past user behavior data. The server receives, as input, the user identification information from the parsed object of Step 5. The server processes this input by querying a storage device for past records associated with the user, such as prior selections, previously issued search queries, and interaction logs. The server converts these records into numeric feature vectors using predetermined encoding functions (for example, topic counts and category frequencies), and outputs one or more user behavior feature vectors.

### Step 9:

The server generates user attribute information from behavior features. The server receives, as input, the user behavior feature vectors from Step 8. The server processes these inputs by applying a trained neural network or other machine learning model that maps the vectors to user attribute values such as interest attributes and preference attributes. The model computes weighted sums and nonlinear activations across layers to produce topic probabilities and preference scores. The server outputs user attribute information represented as structured data, such as a vector of topic scores and numeric indicators of preference tendencies.

### Step 10:

The server generates deterministic search candidate terms. The server receives, as input, the feature terms from Step 7 and the user attribute information from Step 9. The server processes these inputs by applying template-based rules and combination algorithms that merge feature terms with generic query templates (for example, “[entity] background,” “[entity] reason,” “[entity] detailed explanation”). The server scores each generated candidate term by combining the relevance scores of the feature terms and the weights derived from user attributes, and outputs a ranked list of deterministic search candidate terms.

### Step 11:

The server constructs a prompt sentence for a generative AI model. The server receives, as input, the feature terms and the user attribute information. The server processes these inputs by embedding the feature terms and summarized user attributes into a natural language instruction. For example, the server concatenates the main phrase extracted from the text with a description of user interests and desired output style. The server may construct a prompt sentence such as: “From the phrase ‘2023 Nobel Peace Prize laureate’ and considering that the user is highly interested in international politics and human rights, generate 3 to 5 concise search queries that will help the user obtain more detailed information.” The server outputs this prompt sentence as a character string.

### Step 12:

The server invokes the generative AI model with the prompt sentence. The server receives, as input, the prompt sentence from Step 11. The server processes this input by tokenizing the prompt sentence using the tokenizer associated with the generative AI model, mapping tokens to embeddings, and executing a forward pass through a transformer-based neural network or other generative architecture stored in memory. The server computes attention weights, applies linear transformations and nonlinear activation functions at each layer, and outputs a probability distribution over tokens at each generation step. The server decodes these distributions to produce one or more generative search candidate terms, and outputs a group of generated search candidate term strings.

### Step 13:

The server integrates deterministic and generative candidate terms. The server receives, as input, the deterministic search candidate term list from Step 10 and the generative search candidate term group from Step 12. The server processes these inputs by normalizing the terms (for example, by converting to a standard form and removing stopwords), embedding the terms into a vector space using a text embedding model, and computing similarity scores between pairs of terms. The server removes duplicate or near-duplicate terms based on similarity thresholds, filters out terms that lack required entities or fall outside a defined topic scope, and outputs a consolidated final set of search terms with associated baseline ranking scores.

### Step 14:

The server estimates the user's emotional state. The server receives, as input, biometric information and behavior history information associated with the current session, which may be transmitted from the terminal or from connected sensors. The server processes these inputs by extracting relevant features (for example, facial-expression descriptors, voice prosody statistics, or interaction timing patterns) and applying an emotion estimation module such as a neural classifier. The module computes likelihoods for different emotional states based on model parameters and the extracted features. The server outputs an emotional state representation, such as a probability distribution or continuous arousal and valence values.

### Step 15:

The server adjusts the ranking of search terms based on the emotional state. The server receives, as input, the final set of search terms with baseline scores from Step 13 and the emotional state representation from Step 14. The server processes these inputs by applying an adjustment function that increases or decreases term scores according to the emotional state (for example, assigning higher scores to explanatory terms when confusion is high). The server recomputes the order of search terms based on the adjusted scores and outputs an emotion-adjusted final set of search terms in ranked order.

### Step 16:

The server transmits the adjusted search terms to the terminal. The server receives, as input, the emotion-adjusted final set of search terms from Step 15. The server processes this input by packaging the ranked terms into a response object, serializing the response into a message format such as JSON, and sending the message to the terminal via the communication interface. The server outputs an HTTP or HTTPS response containing the search terms and optional auxiliary data such as ranking scores.

### Step 17:

The terminal presents the search terms to the user. The terminal receives, as input, the response message from the server containing the ranked search terms. The terminal processes this input by parsing the message, extracting the list of search terms, and generating corresponding user interface elements such as clickable buttons or list items. The terminal outputs a visual presentation of the search terms on the display so that the user can recognize each candidate query and select one.

### Step 18:

The user selects a search term and requests further processing. The terminal receives, as input, a selection event indicating that the user has chosen one of the displayed search terms. The terminal processes this input by identifying the specific selected search term and determining a configured action, such as performing an external search or creating an additional prompt sentence. The terminal outputs either a search request to an external search engine or a text string representing an additional prompt sentence to be sent to the server, for example: “Explain in detail the reasons why the laureate received the 2023 Nobel Peace Prize.”

### Step 19:

The server processes the additional prompt sentence with the generative AI model. The server receives, as input, the additional prompt sentence from the terminal, together with contextual information such as the original region of interest and user attributes. The server processes these inputs by performing tokenization, embedding, and neural inference in the generative AI model similarly to Step 12, but with a generation configuration aimed at producing explanatory text instead of short queries. The server outputs a generated text response containing detailed information related to the selected search term.

### Step 20:

The terminal displays the generated detailed information to the user. The terminal receives, as input, the generated text response from the server. The terminal processes this input by decoding the text, formatting it into paragraphs or sections, and rendering it within a display area such as a scrollable text view. The terminal outputs visual information that presents the detailed explanation to the user, enabling the user to obtain in-depth, context-aware information derived from the original region of interest and the selected search term.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern computing environments, user terminals such as client devices, head-mounted displays, and other interactive equipment allow users to access large volumes of digital information, including text content and image content. Conventional information retrieval systems typically require a user to manually formulate search queries in a search box, based solely on the user's own understanding of the content and without direct support from the underlying computing system. As a result, such systems often fail to leverage the detailed interaction context of the user, including which portion of the content has been selected, how that portion is semantically structured, and what emotional state the user exhibits at the time of selection.

In many existing systems, natural language processing engines and search engines are used as separate, loosely coupled components. A processor may perform keyword extraction or entity recognition, but the extracted information is not systematically transformed into optimized search terms or prompt sentences tailored for interaction with advanced generative models. Further, the systems typically do not integrate emotion estimation into the core query-generation pipeline. Consequently, the computing process remains largely static and generic, providing search suggestions that are not aligned with the user's moment-to-moment interest, intent, or emotional state.

Moreover, when generative models are used, conventional approaches often treat them as generic answer-generation tools. The prompt sentences sent to such models are frequently handcrafted, fixed, or only lightly templated, and do not fully utilize structured analysis of the user's selected content and user-specific signals. This leads to suboptimal use of computational resources and can reduce the accuracy, relevance, and responsiveness of the system from the standpoint of computer performance, such as inefficient model invocation, redundant processing, and poor ranking of generated outputs.

Accordingly, there is a need for an improved computer-implemented system that (i) captures fine-grained selection information from a user interface on a terminal, (ii) performs structured normalization and analysis of the selected data using natural language processing and image recognition, (iii) generates machine-optimized prompt sentences for a generative information processing model, and (iv) dynamically adapts information search terms and prompt sentences based on an estimated emotional state of the user. Such a system should improve the operation of the computer itself, including the way the processor coordinates content analysis, model invocation, and user-interface presentation, so that the generated search terms and inquiry prompts are both computationally efficient and contextually relevant.

The specific processing by the specific processing unit 290 of the data processing device 12 in Application Example 2 is realized by the following means.

The present invention provides a server comprising a processor configured to cause a terminal to display information content and to receive, via a user interface, a selection operation by a user on a part of the information content, to acquire data corresponding to the selected part together with auxiliary information related to the data, to perform character-string processing or image processing on the acquired data to normalize the data, to extract target terms or concepts from the normalized data by natural language processing processing or image recognition processing, to generate a prompt sentence for instructing a generative information processing model to perform analysis, the prompt sentence being based on the extracted terms or concepts and the auxiliary information, to input the prompt sentence to the generative information processing model and obtain an analysis result, to generate a plurality of related information search terms based on the analysis result and the extracted terms or concepts and to generate display data for presenting the information search terms to the user, to estimate an emotional state of the user based on input information associated with the selection operation or on content of the selected information, to select, reorder, or modify at least part of the generated information search terms in accordance with the emotional state, and to generate, from at least part of the generated information search terms, an inquiry prompt sentence suitable for input to the generative information processing model and to make the inquiry prompt sentence presentable via the user interface. This enables the computing system to more efficiently and effectively process user-selected content by coordinating normalization, semantic analysis, emotion estimation, search-term generation, and prompt construction in an integrated manner, thereby improving the quality and relevance of generated search terms and inquiry prompts and enhancing the overall operation of the computer-based information retrieval and generative processing workflow.

The term “processor” refers to a hardware computation unit or a combination of hardware and control software that executes instructions to perform data processing operations, control flows, and input/output management within the system.

The term “terminal” refers to an electronic device operated by a user, such as a client device or display device, that presents information content, receives user input, and communicates with the server.

The term “user interface” refers to a software-controlled input/output environment, including graphical elements, touch controls, or other interaction modalities, through which the user views information content and performs selection operations.

The term “information content” refers to digital data presented to the user, including but not limited to text data, image data, video data, and associated metadata that can be displayed or otherwise output by the terminal.

The term “selection operation” refers to an action performed by the user via the user interface, such as clicking, tapping, dragging, or otherwise indicating a part of the information content, in order to specify that part as a target for further processing.

The term “data corresponding to the selected part” refers to digital data that represents the portion of the information content designated by the selection operation, including text segments, image regions, coordinate data, or identifiers of such portions.

The term “auxiliary information” refers to contextual data associated with the selected part, such as document identifiers, location information within the content, timestamps, language codes, device-related information, or user-session information.

The term “character-string processing” refers to computational operations performed on text data, such as encoding conversion, normalization of whitespace, removal of control characters, tokenization, or other text preprocessing procedures.

The term “image processing” refers to computational operations performed on image data, such as decoding, resizing, cropping, compression, or other preprocessing procedures that prepare image data for analysis.

The term “normalize the data” refers to converting the acquired data into a standardized form suitable for further analysis, including harmonizing encodings, formats, scales, or structures of text or image data.

The term “natural language processing processing” refers to a series of computational techniques that analyze and interpret human language, including tokenization, part-of-speech tagging, syntactic parsing, named entity recognition, key-phrase extraction, and semantic analysis.

The term “image recognition processing” refers to a series of computational techniques that analyze image data to identify visual objects, regions, landmarks, text, or other visual concepts relevant to the selected part.

The term “target terms or concepts” refers to representative linguistic or semantic units, such as keywords, key phrases, entities, topics, or labels, extracted from the normalized data by natural language processing processing or image recognition processing.

The term “generative information processing model” refers to a machine learning model, such as a generative artificial intelligence model, that produces output data including text or other structured information in response to an input prompt sentence.

The term “prompt sentence” refers to a textual input sequence that encodes an instruction or query to be provided to the generative information processing model in order to cause the model to perform a specified analysis or generation task.

The term “analysis result” refers to data output by the generative information processing model in response to the prompt sentence, including extracted information, inferred relationships, proposed keywords, or other semantically processed content.

The term “information search terms” refers to words, phrases, or expressions generated based on the analysis result and the target terms or concepts, which are suitable for use as queries in information retrieval or search processes.

The term “display data” refers to data structures or formatted content generated by the processor for controlling the terminal to visually or otherwise present information search terms or other outputs to the user through the user interface.

The term “emotional state” refers to an estimated affective condition of the user, such as interest, curiosity, joy, concern, or other emotional attributes, determined from user-related input information.

The term “input information associated with the selection operation” refers to data that reflects the user's behavior or interaction during or around the selection operation, such as timing information, interaction patterns, or additional user input signals.

The term “content of the selected information” refers to the semantic or perceptual substance of the data corresponding to the selected part, including its linguistic meaning, visual features, or contextual role within the overall information content.

The term “select, reorder, or modify” refers to operations performed by the processor on a set of information search terms, including choosing a subset, changing the order of presentation, altering wording, or otherwise adjusting the terms.

The term “inquiry prompt sentence” refers to a prompt sentence specifically formed from at least part of the information search terms and optimized for input to the generative information processing model in order to obtain detailed or follow-up information.

The term “emotion estimation function” refers to a computational function, implemented by software, hardware, or a combination thereof, that receives the selected information or data relating to an action of the user as input and outputs an estimation of the user's emotional state.

The term “data relating to an action of the user” refers to information that characterizes user behavior, such as interaction logs, gesture patterns, gaze positions, voice data, or other sensor-based signals associated with the user's activity.

The term “past usage history data” refers to stored records of previous interactions of the user with information content or the system, including past selections, queries, search terms, or other interaction events.

The term “interest or preference of the user” refers to user-specific tendencies or patterns regarding topics, content types, or interaction styles, inferred from past usage history data or other user-related information.

In one embodiment, the invention is implemented as a distributed computer system including at least one server, at least one terminal, and a communication network interconnecting the server and the terminal. The terminal is, for example, a smartphone, a tablet device, a head-mounted display, a notebook computer, or a desktop computer equipped with a display, at least one input device such as a touchscreen, mouse, or keyboard, and a network interface. The server is, for example, an information processing apparatus including one or more central processing units (CPUs), one or more graphics processing units (GPUs) or specialized accelerators, main memory, non-volatile storage, and a network interface, and executes program modules stored in the storage.

The server executes, under control of a processor, a plurality of software modules including at least: a communication module, a normalization module, a natural language processing module, an image recognition module, an emotion estimation module, a generative AI model interface module, a search-term generation module, a prompt-sentence generation module, and a presentation control module. The terminal executes a user interface module that cooperates with the server.

The terminal displays information content to a user. The terminal renders, on a display, text content such as web pages, documents, and news articles, and image content such as photographs and illustrations. The terminal provides a user interface through which the user performs a selection operation on a part of the displayed content. The terminal receives user input operations, such as a drag operation that designates a character range in the text, or a tap or drag operation that designates a rectangular region in the image. The terminal stores, in a structured record, identifiers of the displayed content, coordinates of the selected portion, and contextual information such as a document URL, a title, a timestamp, and a language code.

The terminal transmits the structured record to the server through the communication network. The terminal uses, for example, an HTTPS protocol and encodes the record in a structured message format. The terminal thereby enables the server to receive an explicit indication of the portion of content that is of interest to the user, rather than requiring the server to infer interest from entire documents.

The server receives the structured record via the communication module and stores it temporarily in a request buffer in main memory. The server refers to a content storage unit or requests, from the terminal, additional content data when the selected data is represented by identifiers and coordinates only. When text data is available, the server passes the text to the normalization module. The normalization module converts the text encoding to a unified format, such as UTF-8, removes non-printable control characters, normalizes whitespace sequences, and standardizes line break codes. The normalization module also performs language detection using a statistical language classifier in order to select an appropriate linguistic model in later processing.

When image data is involved, the server passes the image to the normalization module. The normalization module decodes image data using a standard image processing library, resizes the image region to a reference resolution, and converts the color space to a standardized format. This normalization reduces computational load and memory usage in subsequent recognition steps, thereby improving processing speed and reducing communication overhead when intermediate representations are exchanged between modules.

The server performs natural language processing on normalized text using the natural language processing module. The server uses, for example, a pipeline implemented with a general-purpose natural language processing library. The pipeline includes tokenization, part-of-speech tagging, lemmatization, syntactic dependency parsing, and named entity recognition. The server computes, for each token and phrase, feature vectors including part-of-speech tags, dependency roles, and contextual embeddings obtained from a pre-trained transformer-based language model. The server may employ models such as a transformer encoder with multiple self-attention layers, a hidden size on the order of several hundred dimensions, and a number of attention heads sufficient to capture long-range dependencies. The server obtains contextualized representations that differ from simple bag-of-words statistics and allow more precise identification of key entities and concepts.

The server uses the image recognition module when image regions are selected. The server passes normalized image data to a convolutional neural network or similar vision architecture. The server uses, for example, a convolutional network with multiple convolutional and pooling layers followed by fully connected layers, trained for object classification and landmark recognition. The server computes high-level feature maps and applies a classifier to produce labels and confidence scores corresponding to objects or landmarks in the selected image region. The server may also apply an optical character recognition component to extract text included in the image region.

The server generates, from text and image analysis results, internal data structures representing “target terms or concepts.” The server creates, for example, a term object that includes a string representation, a term type (entity, noun phrase, label, topic), a salience score computed from frequency and model-based importance, and a link to the original position in the content. The server maintains these term objects in a term list associated with the selection request. This structured representation enables the server to apply later ranking and filtering algorithms based on quantitative scores instead of ad-hoc string processing.

The server performs emotion estimation using the emotion estimation module. The server supplies, as input to the emotion estimation module, one or more of: the normalized text of the selected content, the interaction pattern of the user (for example, dwell time, number of corrections in the selection, speed of operations), and optional sensor data from the terminal such as facial images or voice signals. The emotion estimation module may include a neural network classifier that receives as features text embeddings, statistical features of user input timing, and audio or image features. The classifier may be, for example, a multi-layer neural network trained with supervised labels representing emotion categories such as “interest,” “curiosity,” “frustration,” and “boredom.” During training, the server minimizes a loss function such as a cross-entropy function between predicted emotion probabilities and ground-truth labels, and updates model weights using an optimization algorithm such as stochastic gradient descent or a variant thereof. The server integrates the natural language processing results, image recognition results, and the estimated emotional state. The server constructs a context object that contains: the term list, document identifiers, language information, image labels, and a compact representation of the emotional state, such as a vector of emotion scores. This context object is stored in an in-memory data structure accessible by the search-term generation module and the prompt-sentence generation module. By centralizing the information in a structured context object, the server avoids redundant recomputation and reduces memory access overhead.

The server generates a prompt sentence for a generative AI model using the generative AI model interface module and the prompt-sentence generation module. The server constructs a textual prompt that encodes an instruction to a generative information processing model using the target terms or concepts and auxiliary information. The server arranges the terms in a specific order, selects an appropriate natural language instruction template, and embeds the emotional state into the prompt. An example of such a prompt sentence is: “Analyze the following user-selected content and the user's emotion, then generate 10 concise search keywords that the user is likely to find helpful for further exploration. Mark the most important 3 keywords.

Content: [selected text or labels]
Emotion: [emotion labels]”

In another example, when the user selects a portion of a news article about a scientist, the server may construct a prompt such as:

“Please explain in detail the latest research conducted by this scientist, including its background, main findings, and future impact.”

By embedding structured term information and emotional state information into the prompt sentence, the server causes the generative AI model to perform analysis that is closely tailored to the concrete selection context and the user's state, rather than merely generating generic responses.

The server communicates with the generative AI model via the generative AI model interface module. The generative AI model is, for example, a large-scale neural network model of a transformer architecture trained to generate text conditioned on input tokens.

The server tokenizes the prompt sentence, encodes tokens as embeddings, and submits the encoded sequence to the model. The model includes multiple attention layers, each computing attention weights over previous tokens, and generates output tokens sequentially. During training, the model weights are optimized to minimize a sequence-prediction loss function over large corpora. The server may host the model locally on one or more GPUs or may access a remote model service through an application programming interface.

The server receives, as an analysis result, the output generated by the generative AI model. The analysis result may include a ranked list of candidate search terms, annotations of which terms are important, and additional explanatory text. The server parses the output to extract individual terms and associated scores, if present. The server combines these generative outputs with the term objects produced by the natural language processing module and the image recognition module. The server applies a ranking algorithm that considers model-generated importance indicators, salience scores from deterministic analysis, and compatibility with the user's emotional state. For example, the server may increase the rank of terms associated with exploratory or positive content when the emotional state indicates high interest or joy.

The server thereby generates a plurality of information search terms. The server stores these in a search-term list that is structurally similar to the term list but augmented with fields such as a presentation rank and a category attribute. The server then produces display data specifying how the search terms are to be rendered on the terminal user interface. The display data may specify, for example, a layout type, groupings of related terms, and visual emphasis attributes such as font size or color. This representation enables the terminal to render a consistent interactive layout without performing complex analysis locally.

The server generates, using the prompt-sentence generation module, at least one inquiry prompt sentence suitable for direct input to the generative AI model. The server selects one or more of the information search terms and constructs natural-language questions or requests that can be used by the user to obtain detailed explanations or follow-up information. Examples of such prompt sentences include:

“Tell me more about the latest research by this scientist, in an easy-to-understand way.” “Recommend enjoyable things to do around the Eiffel Tower at night, including local tips and must-see spots.”

“Explain the camera features of the new smartphone in detail, including strengths and weaknesses, and compare them with other recent flagship phones.”

The server encodes not only the high-level intent but also the structure of the requested output, such as requesting lists, comparisons, or detailed explanations, thereby reducing the need for the user to manually craft sophisticated queries.

The terminal receives, via the communication module, the display data, the information search terms, and the inquiry prompt sentences. The terminal's user interface module renders the search terms as selectable elements such as buttons or chips, and renders the inquiry prompt sentences as suggested questions. The user may select a search term, in which case the terminal may cooperate with a search engine to retrieve conventional search results. The user may select an inquiry prompt sentence, in which case the terminal may display, for example, a confirmation interface and then send the selected prompt sentence to the generative AI model via the server or directly, depending on configuration. The server can control, in cooperation with the terminal, how frequently the generative AI model is invoked. For example, the server can cache intermediate analysis results for repeated selections in the same document, or can reuse context objects for similar content. This reduces the number of calls to the generative AI model and lowers communication load between the server and model host while maintaining responsiveness. By separating deterministic term extraction from generative refinement and by using structured data objects, the server reduces computational redundancy and makes more efficient use of computational resources.

The described configuration provides technical effects beyond mere automation of human mental processes. The server integrates, within a single pipeline, normalization operations that reduce noise and heterogeneity in input data, multi-modal analysis modules that transform unstructured content into structured term representations, an emotion estimation module that uses specific model architectures and features, and a generative AI model whose prompts are systematically constructed from the structured representations. This integration improves processing accuracy because the generative AI model receives prompts that are tailored to specific selection contexts and emotional states, reducing irrelevant or ambiguous outputs. The integration also improves processing speed, because the server avoids repeated full-document analysis by focusing computation on selected parts and reusing normalized and structured data.

The server further improves technical performance by controlling ranking and selection of information search terms and prompt sentences using quantitative scores, emotional context, and structural constraints. The system thus reduces the amount of data transmitted to the terminal, since only selected, high-value terms and prompts are sent rather than raw analysis outputs. By optimizing prompt sentences for the generative AI model, the server reduces the number of iterations required for the user to obtain satisfactory results, which indirectly reduces network traffic and computational load on the model.

In another embodiment, the server uses a generative model that has been fine-tuned on past usage history data of multiple users. The server records, in a usage history store, which search terms were selected, which prompt sentences were used, and which outputs were evaluated positively by users. The server then trains an additional layer or adapter module attached to the base generative model, using a loss function that rewards generating terms and prompts similar to those that historically led to successful interactions. The server thereby tailors the generative behavior not only to individual selections and emotions but also to long-term user preferences, enabling further improvements in ranking accuracy and user satisfaction.

In yet another embodiment, the emotion estimation module includes separate models for text-based emotion and interaction-based emotion. The server can apply a rule-based fusion mechanism in which text-based emotion is given higher weight when selected content is long and interaction-based emotion is given higher weight when selection operations are repeated or irregular. By using such non-conventional fusion rules and weighting schemes, the server achieves a more stable and robust emotional state estimate than simple averaging, which in turn leads to more appropriate adjustment of search terms and prompts.

In a further embodiment, the system can be applied to devices with limited computing resources, such as lightweight head-mounted displays. In this case, the terminal performs only minimal preprocessing, such as collecting coordinate data and low-resolution snapshots, and the server performs the majority of the computation. Because the server uses normalization, structured term objects, and caching, the system maintains low latency even under constrained network conditions. Thus, the invention improves the technical field of interactive information systems by enabling complex multi-stage content and emotion analysis with reduced resource consumption and improved performance.

By these configurations and variations, the server, the terminal, and the user cooperate through specific data structures, neural network architectures, and prompt-construction algorithms that are not mere mental processes or generic automation of human tasks. The system instead implements a concrete improvement to computer technology itself, in how a processor encodes user selections into structured representations, orchestrates multiple analysis modules, constructs optimized prompt sentences for a generative AI model, and controls data flows and ranking algorithms to achieve higher accuracy, higher speed, and lower resource consumption in information retrieval and generative processing.

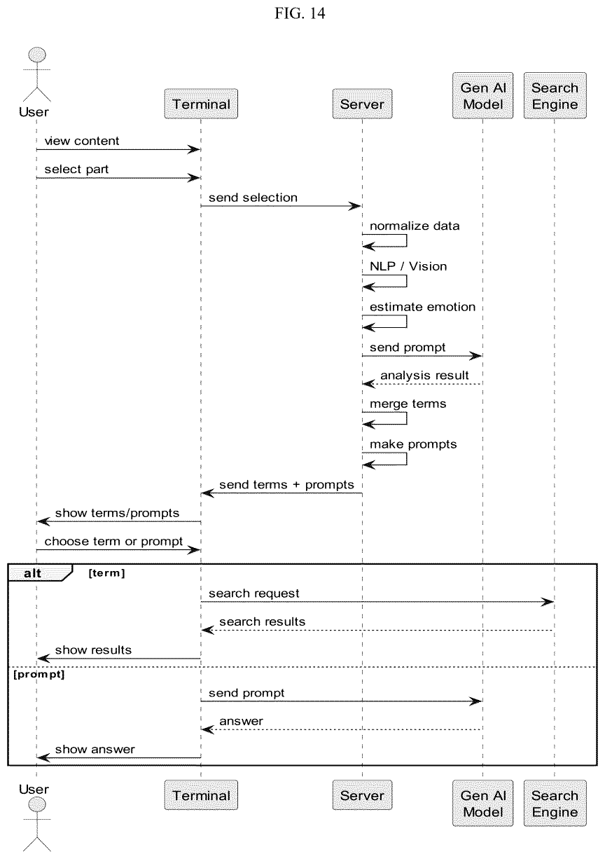

The following describes the processing flow using FIG. 14.

### Step 1:

User views information content and selects a part of interest.

User operates the terminal to display digital information content such as a document, a web page, or an image on the screen. User performs a selection operation, for example by dragging a finger over text, double-tapping a word, or drawing a rectangle over a region of an image.

Input: Visually displayed content on the terminal and user interaction events (touch, mouse, or similar).

Output: A selection indication that includes at least a content identifier, text range positions or image region coordinates, and a timestamp.

### Step 2:

Terminal generates structured selection data and sends it to the server.

Terminal reads the selection indication stored in an internal buffer, extracts the selected text substring or crops the selected image region, and attaches auxiliary information such as document URL, title, language code, device identifier, and session identifier. Terminal constructs a structured data object including the selected data and auxiliary information, and transmits this object to the server over a secure communication channel.

Input: Selection indication (content identifier, coordinates or text range) and context data stored in the terminal.

Output: A structured selection message sent to the server, containing selected content data and auxiliary information.

### Step 3:

Server receives the structured selection message and normalizes the data.

Server accepts the structured selection message via a communication interface, parses the message, and separates text data, image data, and auxiliary information. For text data, server converts the character encoding to a unified format, removes invalid control characters, and normalizes whitespace. For image data, server decodes the binary image, resizes the image region to a standard resolution, and converts the color space into a standardized representation.

Input: Structured selection message including raw text or image data and auxiliary information.

Output: Normalized text data or normalized image data and a cleaned auxiliary information record stored in server memory.

### Step 4:

Server performs content analysis using natural language processing or image recognition.

Server passes normalized text to a natural language processing pipeline to perform tokenization, part-of-speech tagging, lemmatization, dependency parsing, and named entity recognition, and computes feature vectors for words and phrases. For image data, server inputs the normalized image to an image recognition module to obtain labels, detected objects, landmarks, and, if applicable, recognized text. Server aggregates analysis results into a list of target terms or concepts, each associated with importance scores and type information.

Input: Normalized text or normalized image, along with auxiliary information.

Output: A structured list of target terms or concepts, each with attributes such as term string, type, and salience score, linked to the selection.

### Step 5:

Server estimates the user's emotional state from content and interaction data.

Server retrieves the normalized text of the selected content, interaction metrics such as selection duration or number of selection adjustments, and any additional user-related signals provided by the terminal. Server feeds these features into an emotion estimation module that applies a trained classifier to infer emotion scores for categories such as interest, curiosity, or frustration. Server stores the resulting emotional state representation in association with the current selection.

Input: Normalized content data, interaction metrics, and optional sensor-derived features.

Output: An emotional state descriptor, for example a set of emotion labels and numeric scores, linked to the selection context.

### Step 6:

Server compiles a context object integrating terms, auxiliary information, and emotional state.

Server creates a context object in memory that combines the list of target terms or concepts, the auxiliary information (document identifiers, language, metadata), and the emotional state descriptor. Server organizes this data into fields and references so that subsequent modules can efficiently access the necessary information without repeating earlier computations.

Input: List of target terms or concepts, auxiliary information record, and emotional state descriptor.

Output: A context object containing unified content analysis and emotion information for the selection.

### Step 7:

Server generates a first set of candidate information search terms.

Server examines the context object to select important terms based on salience scores, term types, and their positions in the content. Server combines related terms into compound phrases and normalizes their surface forms, for example by lemmatizing verbs or merging adjacent nouns. Server thereby constructs an initial list of candidate information search terms closely tied to the selected content.

Input: Context object including target terms or concepts and auxiliary information.

Output: An initial candidate search-term list, each entry including a term string and an internal rank or weight.

### Step 8:

Server constructs a prompt sentence for the generative AI model.

Server uses the context object and the candidate search-term list to assemble a prompt sentence that instructs a generative AI model to perform analysis. Server inserts selected terms, short excerpts of the selected content, and a representation of the emotional state into a textual instruction template. For example, server may generate:

“Analyze the following user-selected content and the user's emotion, then generate 10 concise search keywords that the user is likely to find helpful for further exploration. Mark the most important 3 keywords.

Content: [selected content]

Emotion: [emotion labels]”

Input: Context object and candidate search-term list.

Output: A structured prompt sentence tailored to the selection and emotional state.

### Step 9:

Server sends the prompt sentence to the generative AI model and obtains an analysis result.

Server encodes the prompt sentence into model-specific input format and transmits it to the generative AI model through an interface module or a model service. The generative AI model processes the prompt and generates textual output including suggested keywords, rankings, or related queries. Server receives the generated text and parses it to extract individual terms, indicators of importance, and any additional descriptions.

Input: Prompt sentence constructed for the generative AI model.

Output: An analysis result consisting of generated candidate search terms and associated annotations.

### Step 10:

Server merges deterministically derived terms with generative model output and refines search terms.

Server combines the candidate search-term list obtained from deterministic analysis with the set of terms returned by the generative AI model. Server removes duplicates, aligns synonyms, and adjusts scores by considering both salience from deterministic processing and importance indicators from the model output. Server uses the emotional state descriptor to adjust rankings, for example promoting terms reflecting exploratory or reassuring information when the emotional state indicates high curiosity or concern.

Input: Deterministic candidate search-term list, generative model analysis result, and emotional state descriptor.

Output: A refined and ranked list of information search terms calibrated to the user's selection and emotional state.

### Step 11:

Server generates inquiry prompt sentences based on refined information search terms.

Server selects one or more of the refined information search terms and generates natural-language question sentences that are suitable for direct input to the generative AI model. Server uses templates and structural rules to create prompts that request detailed explanations, practical advice, or comparisons. For example, server may produce:

“Tell me more about the latest research by this scientist, in an easy-to-understand way.”

“Recommend enjoyable things to do around the Eiffel Tower at night, including local tips and must-see spots.”

Server then associates each inquiry prompt sentence with the corresponding search term.

Input: Refined and ranked list of information search terms and context object.

Output: A set of inquiry prompt sentences linked to respective information search terms.

### Step 12:

Server prepares presentation data and transmits it to the terminal.

Server constructs presentation data that specifies the refined information search terms, their display order, groupings, visual emphasis attributes, and the associated inquiry prompt sentences. Server encapsulates this presentation data into a response message and sends it to the terminal through the communication interface.

Input: Refined search-term list and set of inquiry prompt sentences.

Output: A presentation response message containing search terms and prompt sentences ready to be displayed.

### Step 13:

Terminal renders information search terms and inquiry prompt sentences to the user.

Terminal receives the presentation response message, parses the search terms and prompt sentences, and draws them on the display as interactive elements. Terminal may present search terms as selectable chips or buttons near the selected content and show inquiry prompt sentences as recommended questions in a separate panel or overlay.

Input: Presentation response message from the server.

Output: A rendered user interface that visually presents selectable search terms and inquiry prompt sentences.

### Step 14:

User selects a search term or an inquiry prompt sentence.

User interacts with the displayed interface on the terminal by tapping or clicking one of the information search terms or one of the inquiry prompt sentences. The terminal recognizes the selected element and prepares a subsequent request depending on the type of element chosen.

Input: Displayed search terms and inquiry prompt sentences and user interaction events.

Output: A selection event indicating which search term or prompt sentence has been chosen by the user.

### Step 15:

Terminal initiates a follow-up operation based on the user's choice.

Terminal, in response to a selected search term, may formulate a conventional search request and send it to a search engine, then display the search results. In response to a selected inquiry prompt sentence, terminal may either forward the prompt sentence to the server for submission to the generative AI model or send it directly to a generative AI service, depending on configuration. Terminal then presents any returned explanations or results to the user in an integrated view.

Input: Selection event for a search term or inquiry prompt sentence and, for prompts, the textual content of the chosen prompt sentence.

Output: A follow-up result such as a list of search results or a generated explanation displayed to the user on the terminal.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

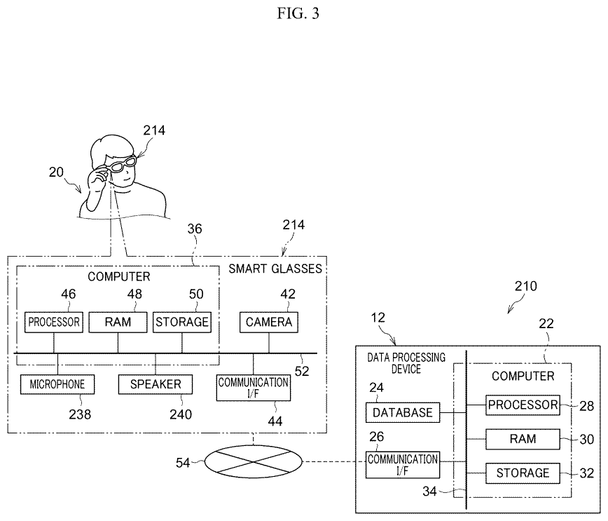

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

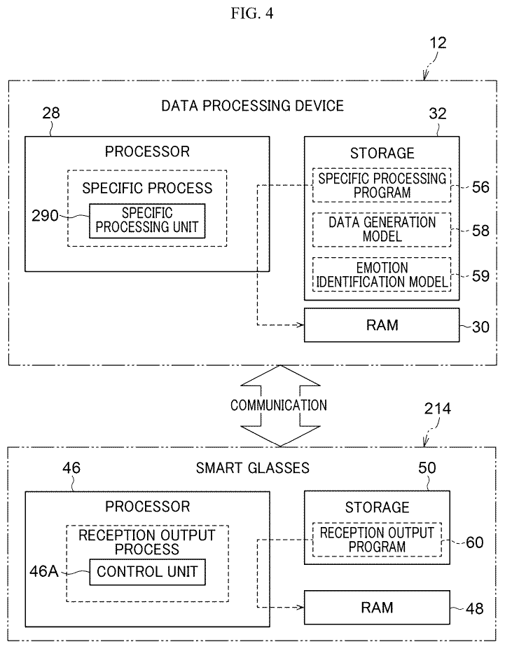

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

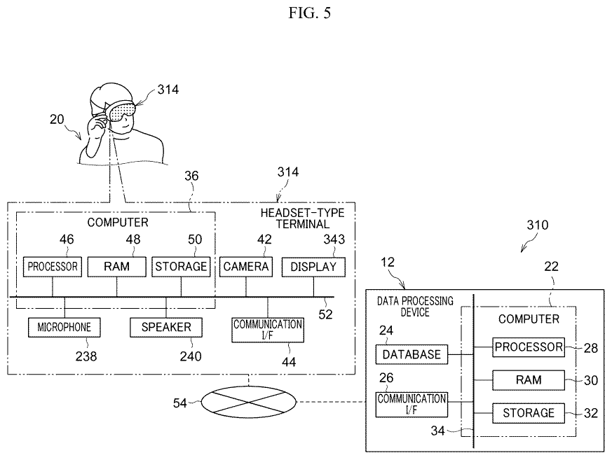

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

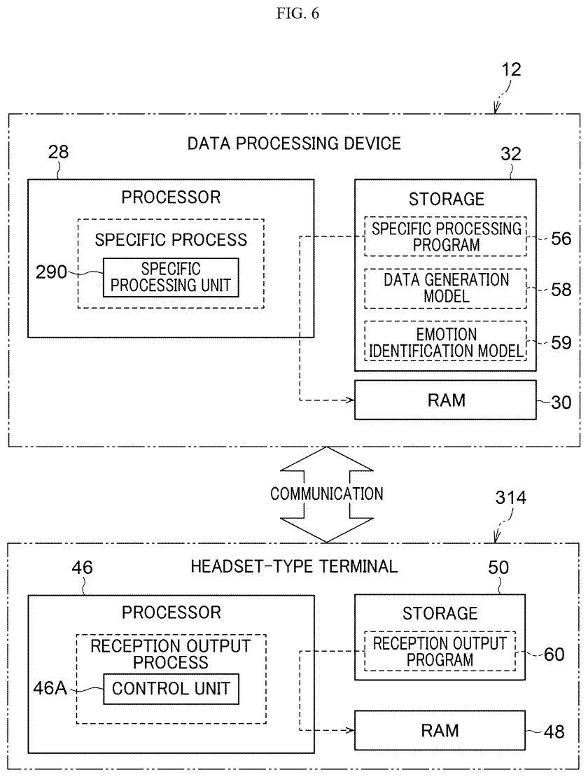

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56.

The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

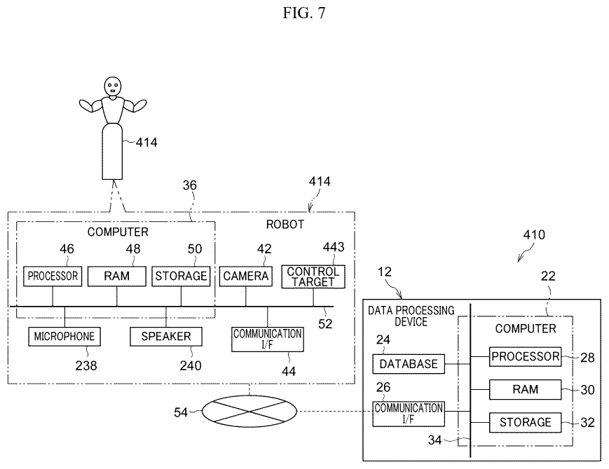

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

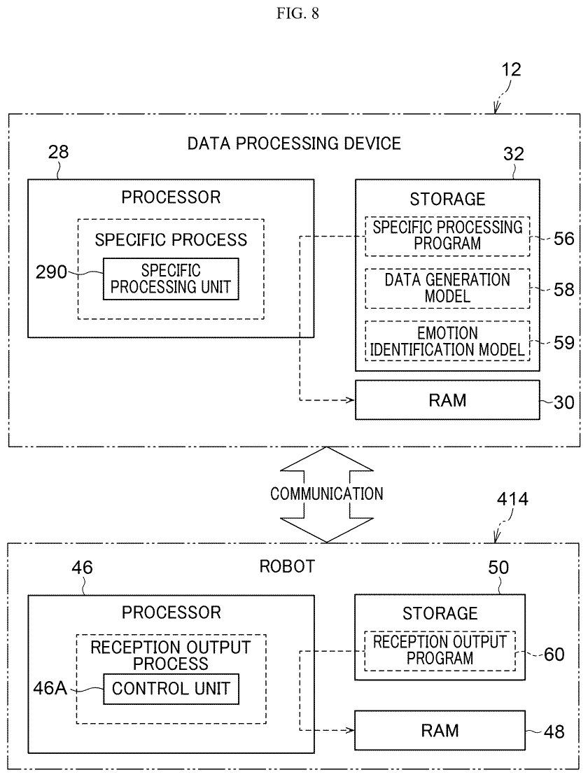

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

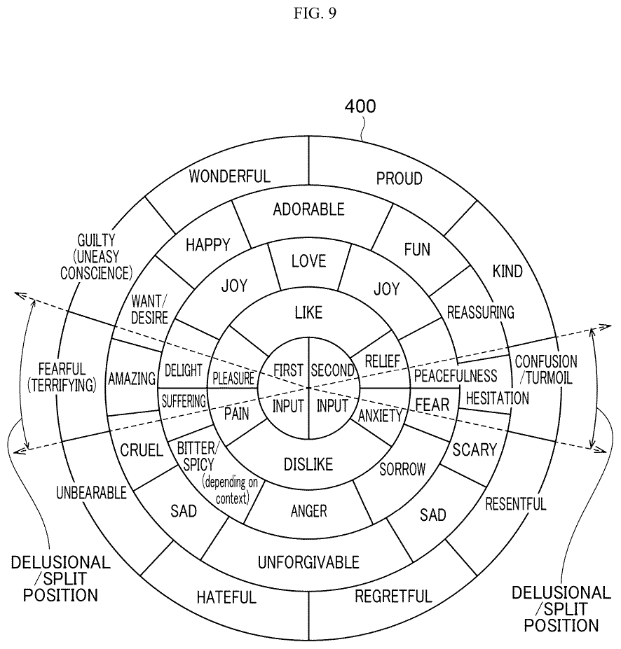

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

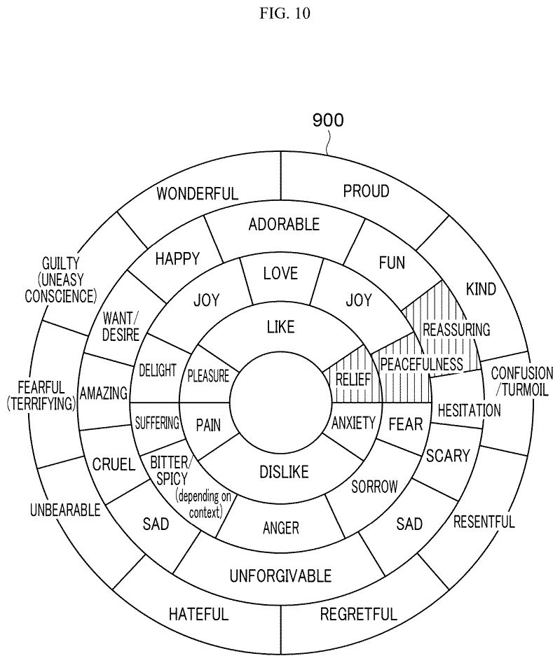

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a user interface, an instruction from a user to designate a region of interest within at least a part of a display area of information content or an image acquired by an image acquisition device, using an input/output device including a pointing device or a touch detection device, and acquire coordinate information in the display area and character information or image information in an information resource corresponding to the coordinate information,
analyze the acquired character information by using an information processing resource including a natural language processing apparatus or a natural language processing service to perform character string analysis and extract semantic information and concept information, and analyze the acquired image information by using an information processing resource including an image recognition apparatus or an image recognition service to perform object detection, target identification, or character recognition and extract object information and attribute information, and generate analysis result data by integrating extraction results of the character information and the image information, construct a prompt sentence including at least a summary of the analysis result data, extracted concept information, and generation conditions, based on the analysis result data and attribute information or behavior history information relating to the user, and transmit the prompt sentence together with instruction information requesting an inference process to a generative AI model, such that the generative AI model generates response information including a plurality of information retrieval terms related to the analysis result data,
acquire the response information from the generative AI model, extract the information retrieval terms from the response information, perform duplicate elimination processing, safety determination processing, and relevance calculation processing on the information retrieval terms, determine a plurality of candidate retrieval terms associated with ranking information, and present the determined candidate retrieval terms, together with classification information and relevance information, to the user via the user interface, acquire expression information, voice information, or operation information of the user, estimate an emotional state of the user by using an emotion recognition apparatus or an emotion recognition program based on the acquired information, and adjust content or presentation order of the candidate retrieval terms in accordance with the emotional state, and
generate request information in which a candidate retrieval term selected by the user is used as a retrieval request, transmit the request information to an information retrieval apparatus or an information retrieval service, acquire a retrieval result, and present the retrieval result to the user via the user interface.

### (Supplementary 2)

The system according to supplementary 1,
wherein the processor is configured to
cooperate with an emotion estimation engine that estimates the emotional state of the user based on signals from an input device that acquires the expression information, voice information, or operation information of the user, and change selection, generation conditions, or presentation format of the candidate retrieval terms by using the estimated emotional state.

### (Supplementary 3)

The system according to supplementary 1,
wherein the processor is configured to
use a storage device that stores the attribute information and the behavior history information relating to the user, and a trained generative AI model that has learned an interest or a preference of the user based on the behavior history information stored in the storage device, and apply the trained generative AI model to construction of the prompt sentence or generation of the information retrieval terms, thereby presenting the candidate retrieval terms corresponding to the interest or the preference of the user.

### Application Example 1

### (Supplementary 1)

A system comprising a processor,
wherein the processor is configured to
cause a user interface including an input device or a gaze detection device and a display device to specify a region of interest among information data displayed on the display device or image data acquired by an imaging device, and to acquire position information and content data corresponding to the region of interest,
classify the acquired content data into text data and image data, execute an analysis process on the text data by using a natural language processing program including at least tokenization, part-of-speech tagging, named entity extraction, and topic extraction, execute an analysis process on the image data by using an image processing program or a machine learning model including at least object detection, face detection, region extraction, and feature calculation, and integrate the respective analysis results to generate structured data representing a user intention or a user interest target,
acquire related information candidates from a related information candidate database or a search index on the basis of the generated structured data, generate a prompt sentence for a generative AI model by using the related information candidates and the structured data, input the prompt sentence into the generative AI model, and obtain generated result data including at least an explanatory text of related information or recommendation information,
generate, on the basis of the obtained generated result data, at least one of a search term sequence or a recommendation information list, present the search term sequence or the recommendation information list via the user interface, recognize a user emotion by using an emotion recognition program that estimates an emotional state on the basis of at least one of facial information, voice information, or operation history information of the user, and adjust content or presentation order of the search term sequence or the recommendation information list in accordance with the recognized emotional state, and update the generative AI model or a recommendation algorithm by using past behavior history data and attribute data of the user as learning data, and individually optimize, on the basis of the structured data, the emotional state, and the behavior history data, at least one of a prompt sentence to be generated in a subsequent process and generated result data of related information.

### (Supplementary 2)

The system according to supplementary 1,
wherein the processor is configured to use, as the emotion recognition program, an emotion engine program that applies an emotion estimation algorithm to data acquired from a biological information detection device or a voice acquisition device to recognize the user emotion.

### (Supplementary 3)

The system according to supplementary 1,
wherein the processor is configured to use, for generating at least one of the prompt sentence or the generated result data, a generative AI model whose parameters are adjusted by learning behavior history data including at least access history, selection history, and stay time information of the user, in order to present the search term sequence or the recommendation information list reflecting an interest or a preference of the user.

### Example 2

### (Supplementary 1)

A system comprising a processor,
wherein the processor is configured to
cause a user interface to receive, from a user, a designation of a region of interest within information data presented as visual information, and to acquire text data corresponding to the designated region of interest together with user identification information and attribute information of the information data,
transmit, via a communication unit, the text data corresponding to the designated region of interest, the user identification information, and the attribute information of the information data to an information processing apparatus,
control the information processing apparatus to analyze the text data corresponding to the designated region of interest by using natural language processing software to perform at least morphological analysis, syntactic analysis, and semantic analysis, and to extract feature terms from a result of the analysis,
control the information processing apparatus to read, from a storage device, past user behavior data associated with the user identification information, and to generate user attribute information based on the past user behavior data,
control the information processing apparatus to generate a plurality of search candidate terms for acquiring related information, based on the feature terms and the user attribute information,
control the information processing apparatus to generate a prompt sentence that includes at least the feature terms and the user attribute information as input information to a generative information processing model, and to transmit the prompt sentence to the generative information processing model in order to instruct the generative information processing model to perform analysis processing and to acquire, from the generative information processing model, a group of candidate search terms,
control the information processing apparatus to integrate the plurality of generated search candidate terms with the group of candidate search terms acquired from the generative information processing model, to remove duplicate elements and irrelevant elements from the integrated terms, and to determine a final set of search terms,
control a user state estimation engine to estimate an emotional state of the user based on at least one of biometric information and behavior history information, and to adjust at least one of weighting and display order of the search terms included in the final set of search terms according to the emotional state,
and cause the user interface to present the adjusted final set of search terms to the user, and, in response to a selection operation by the user on at least one search term included in the adjusted final set of search terms, execute at least one of an external information search process using the at least one search term and a process of generating and transmitting an additional prompt sentence to the generative information processing model.

### (Supplementary 2)

The system according to supplementary 1,
wherein the processor is configured to
control the user state estimation engine as an emotion estimation module that determines the emotional state of the user based on at least one of biometric sensor information and behavior history information of the user.

### (Supplementary 3)

The system according to supplementary 1,
wherein the processor is configured to
store, in association with the user identification information, a generative information processing model that has learned interest attributes and preference attributes of the user based on the past user behavior data, and to input, into the generative information processing model, a prompt sentence including at least the text data corresponding to the region of interest and the interest attributes and the preference attributes, so as to cause the generative information processing model to generate search candidate terms, and to present the generated search candidate terms to the user via the user interface.

### Application Example 2

### (Supplementary 1)

A system comprising a processor,
wherein the processor is configured to
cause a terminal to display information content to a user, to receive a selection operation by the user on a part of the information content via a user interface, and to acquire data corresponding to the selected part together with auxiliary information related to the data, to perform character-string processing or image processing on the acquired data to normalize the data, and to extract target terms or concepts from the normalized data by natural language processing or image recognition processing,
to generate a prompt sentence for instructing a generative information processing model to perform analysis, the prompt sentence being based on the extracted terms or concepts and the auxiliary information, and to input the prompt sentence to the generative information processing model and obtain an analysis result,
to generate a plurality of related information search terms based on the analysis result and the extracted terms or concepts, and to generate display data for presenting the information search terms to the user,
to estimate an emotional state of the user based on input information associated with the selection operation or on content of the selected information, and to select, reorder, or modify at least part of the generated information search terms in accordance with the emotional state, and
to generate, from at least part of the generated information search terms, an inquiry prompt sentence suitable for input to the generative information processing model, and to make the inquiry prompt sentence presentable via the user interface.

### (Supplementary 2)

The system according to supplementary 1,
wherein the processor is configured to
use an emotion estimation function that performs emotion estimation processing using, as input, the selected information or data relating to an action of the user, in order to estimate the emotional state of the user.

### (Supplementary 3)

The system according to supplementary 1,
wherein the processor is configured to
use a generative information processing model that has learned an interest or preference of the user based on past usage history data, for generating the information search terms or for generating the inquiry prompt sentence.

What is claimed is:

1. A system comprising:
circuitry configured to:
receive, via a communication interface coupled to a packet-switched network, a selection of a region of interest from among information content displayed on a terminal device or image data acquired by an imaging device of the terminal device;
construct a prompt data structure based on content of the selected region and transmit the prompt data structure to a generative neural network model to instruct the generative neural network model to analyze the content of the selected region using natural language processing, and obtain analysis result data from the generative neural network model;
generate one or more candidate output terms based on the obtained analysis result data and transmit the one or more candidate output terms to the terminal device for presentation via a user interface of the terminal device; and
estimate an emotional state of a user of the terminal device and adjust the generated one or more candidate output terms based on the estimated emotional state.

2. The system according to claim 1, wherein the circuitry is configured to map coordinate information of the selected region to document object model nodes of the information content and to extract character-sequence data and pixel-region data corresponding to the selected region from an information resource.

3. The system according to claim 2, wherein the circuitry is configured to normalize the extracted character-sequence data by converting character encoding to a unified format and removing non-printable control characters prior to constructing the prompt data structure.

4. The system according to claim 3, wherein the circuitry is configured to analyze the extracted character-sequence data using a natural language processing resource to extract semantic feature data comprising entity identifiers and concept descriptors, and to analyze the extracted pixel-region data using an image recognition resource to extract object feature data comprising detected object labels and attribute descriptors.

5. The system according to claim 4, wherein the natural language processing resource performs tokenization, part-of-speech tagging, named entity recognition, and dependency parsing on the normalized character-sequence data, and wherein the semantic feature data further comprises confidence scores associated with each entity identifier.

6. The system according to claim 4, wherein the circuitry is configured to generate integrated analysis result data by merging the semantic feature data and the object feature data into a unified structured representation, and to include the integrated analysis result data in the prompt data structure.

7. The system according to claim 6, wherein generating the integrated analysis result data comprises constructing a graph-based representation in which entity identifiers and object labels are nodes and semantic relationships between the nodes are edges, and applying a canonicalization process to map variant representations to common identifiers.

8. The system according to claim 1, wherein the image recognition resource comprises a convolutional neural network that generates feature maps from image data of the selected region and applies detection heads to output bounding boxes, classification labels, and probability scores for detected objects.

9. The system according to claim 8, wherein the circuitry is configured to apply an optical character recognition component to the image data of the selected region to extract embedded text data and to incorporate the embedded text data into the analysis result data.

10. The system according to claim 1, wherein the prompt data structure comprises at least a summary of the analysis result data, extracted concept descriptors, and generation condition parameters specifying at least an output language, a quantity constraint on the candidate output terms, and a length constraint.

11. The system according to claim 10, wherein the circuitry is configured to incorporate user attribute data stored in a storage device into the prompt data structure, the user attribute data comprising a user interest vector generated from behavior history data of the user using a trained encoder model.

12. The system according to claim 1, wherein the generative neural network model comprises a transformer architecture with self-attention layers, and wherein the circuitry is configured to control inference parameters of the generative neural network model comprising at least one of a temperature parameter, a top-k sampling threshold, or a maximum output length.

13. The system according to claim 12, wherein the circuitry is configured to select, from a plurality of generative neural network models having different parameter sizes, a particular generative neural network model based on a complexity measure derived from the analysis result data.

14. The system according to claim 1, wherein adjusting the generated one or more candidate output terms comprises performing post-processing operations on the candidate output terms comprising duplicate elimination based on vector similarity computation using an embedding model, content compliance filtering, and relevance score calculation to produce ranked candidate terms.

15. The system according to claim 1, wherein the circuitry is configured to estimate the emotional state using an emotion recognition resource comprising a neural network classifier that receives at least one of a facial expression vector derived from image data captured by a camera of the terminal device, acoustic feature data derived from audio captured by a microphone of the terminal device, or interaction timing features derived from input event logs of the terminal device, and outputs a probability distribution over a plurality of discrete emotional state categories.

16. The system according to claim 15, wherein adjusting the candidate output terms based on the estimated emotional state comprises increasing ranking scores of candidate output terms associated with explanatory content categories when the estimated emotional state indicates a confusion or frustration category, and increasing ranking scores of candidate output terms associated with detailed content categories when the estimated emotional state indicates an engagement category.

17. The system according to claim 1, wherein the circuitry is configured to update parameters of the generative neural network model using training data derived from past prompt data structures and corresponding user selection outcomes, by minimizing a loss function that penalizes generated candidate output terms associated with low user engagement metrics.

18. A system comprising:
circuitry configured to:
receive, via a communication interface coupled to a packet-switched network, a selection of a region of interest from among information content displayed on a terminal device or image data acquired by an imaging device of the terminal device;
extract character-sequence data and pixel-region data corresponding to the selected region, analyze the character-sequence data using a natural language processing resource to generate semantic feature data, and analyze the pixel-region data using an image recognition resource to generate object feature data;
generate integrated analysis result data by merging the semantic feature data and the object feature data, and construct a prompt data structure comprising the integrated analysis result data and generation condition parameters;
transmit the prompt data structure to a generative neural network model comprising a transformer architecture with self-attention layers via the packet-switched network, and obtain response data comprising a plurality of candidate output terms;
perform post-processing on the candidate output terms comprising duplicate elimination using vector similarity computation, content compliance filtering, and relevance score calculation;
estimate an emotional state of a user of the terminal device based on at least one of expression data, audio signal data, or interaction pattern data, and adjust a presentation ordering of the candidate output terms based on the estimated emotional state; and
transmit the adjusted candidate output terms to the terminal device for presentation via a user interface of the terminal device.

19. The system according to claim 18, wherein the circuitry is configured to generate, from at least one of the adjusted candidate output terms selected by the user, an inquiry prompt sentence incorporating the selected candidate output term and context data from the integrated analysis result data, and to transmit the inquiry prompt sentence to the generative neural network model to obtain explanatory response data.

20. A method comprising:
receiving, via a communication interface coupled to a packet-switched network, a selection of a region of interest from among information content displayed on a terminal device or image data acquired by an imaging device of the terminal device;
constructing a prompt data structure based on content of the selected region and transmitting the prompt data structure to a generative neural network model to instruct the generative neural network model to analyze the content of the selected region using natural language processing, and obtaining analysis result data from the generative neural network model;
generating one or more candidate output terms based on the obtained analysis result data and transmitting the one or more candidate output terms to the terminal device for presentation via a user interface of the terminal device; and
estimating an emotional state of a user of the terminal device and adjusting the generated one or more candidate output terms based on the estimated emotional state.
